(19) United States
(12) Patent Application Publication
(10) Pub. No.: US 2026/0285753 A1
(43) Pub. Date: Sep. 24, 2026

(54) METHODS FOR REPURPOSING PLASTIC FOR USE IN THE BUILDING INDUSTRY

(71) Applicant: LOW CARBON MATERIALS LIMITED, Seaham (GB)

(72) Inventors: Philip BUCKLEY, Seaham (GB); Scott BUSH, Seaham (GB); Natasha BOULDING, Seaham (GB)

(21) Appl. No.: 19/474,276

(22) PCT Filed: Apr. 12, 2024
(86) PCT No.: PCT/GB2024/050958

§ 371 Date: Oct. 10, 2025

(30) Foreign Application Priority Data
Apr. 14, 2023 (GB) 2305510.6

(51) Int. Cl. C04B 18/02; C04B 18/20; C04B 20/02; C04B 111/00

(52) U.S. Cl. CPC C04B 18/021; C04B 18/20; C04B 20/0232; C04B 2111/00019

(57) ABSTRACT

The present invention relates to a method of manufacturing a carbonated plastic aggregate comprising the steps of: (i) mixing plastic particles and at least one cementitious binder comprising at least one metal oxide or metal silicate to form a first composition, (ii) providing a second composition comprising water; (iii) mixing together the first and second compositions to form a pre-mixture; (iv) agglomerating the pre-mixture to form a plastic aggregate; and (v) carbonating the at least one metal oxide or metal silicate by means of an active carbonation process to obtain the carbonated plastic aggregate.

### FIELD OF INVENTION

The present invention relates to repurposing plastic for use in the building industry.

### BACKGROUND OF THE INVENTION

Presently around 45% of the CO₂ emitted by humans remains in the atmosphere, which is a significant factor behind global warming. Although the biggest source of CO₂ emissions is from burning fossil fuels for electricity, heat and transportation, large quantities of CO₂ are released in the atmosphere due to incineration of waste.

For example, around 25% of all plastic waste is incinerated and this is estimated to be causing the release of 5 million tonnes of CO₂eq in the UK alone (polyurethane (PUR) incineration alone releases 2.44 kg CO₂ eq/kg). It is vital that the burning of plastic waste, particularly PUR, is stopped or limited, in order to help achieve Net Zero.

Although recycling plastic may avoid some of the environmental damage associated with the use of plastic, currently, certain types of plastic are difficult to recycle, in particular foam materials. For instance, one of the most commonly used plastic foams is polyurethane (PUR); this type of foam is not currently recycled, primarily because PUR is a thermoset plastic. Additionally, the only known recycling process for it is incredibly expensive and laborious. Consequently, waste PUR is incinerated or disposed of in landfill.

Therefore, there is a need to repurpose plastic such as waste plastic-based foams for environmental reasons (i.e. limiting the effects of CO₂eq emissions linked to climate change). In addition, such repurposing would also generate economic value, as it would allow a waste product (which would otherwise be incinerated or disposed of in landfill) to be used in the production of a valuable product.

Plastic (such as PUR) powder may be repurposed in concrete, however, the use of plastic with little or no pre-treatment in concrete has proven to result in poor mechanical properties, mainly because of the low compatibility of the plastic with the concrete matrix and high surface area. The incompatibility usually leads to a non-homogeneous distribution of the plastic in the matrix, with a partial or complete segregation of the two materials. The result is a much weaker piece of concrete, compared to the use of aggregate of composite origin.

It would therefore be beneficial to repurpose waste plastic into a plastic aggregate for use in concrete, such that the aggregate would be associated with low CO₂ emissions as the emissions due to the burning of the plastic would be avoided. However, it is crucial that the plastic aggregate is compatible with the concrete matrix, so that once it is incorporated into concrete, it will not detrimentally affect the strength of the resulting concrete.

In addition to or as an alternative to avoiding the emission of CO₂ in the first place, methods have been developed to remove some of the CO₂ already present in the atmosphere or to prevent further emissions from contributing to global warming, such as carbon sequestration.

Carbon sequestration is the capturing, removal and storage of carbon dioxide (CO₂) from the earth's atmosphere. It is recognised as a key method for removing carbon from the earth's atmosphere.

In particular, CO₂ from CO₂-rich sources such as flue gases may be sequestered and utilised for other purposes. For instance, the CO₂ may be reacted with minerals such as magnesium oxide or calcium oxide to form stable carbonates. These minerals may be reused for various purposes, such as in the building industry.

As such, the new plastic aggregate for use in concrete (as referred to above) would ideally be able to further aid in lowering CO₂ emissions, for example by being able to sequester CO₂.

### SUMMARY OF THE INVENTION

The present invention seeks to address the problem outlined above by sequestering CO₂ into a carbonated plastic aggregate. The sequestered CO₂ would otherwise be released (or continue to be present) in the atmosphere.

Additionally, the present invention also provides for the repurposing of waste plastics including waste plastic-based foams (which would otherwise be typically incinerated or disposed of in landfill) into a useable carbonated plastic aggregate for use in manufacturing valuable concrete compositions. The use of “raw” plastic (with little or no pre-treatment) in concrete has proven to result in poor mechanical properties, mainly because of the low compatibility of the plastic with the concrete matrix and high surface area. The present invention “pre-treats” the plastic making it compatible for use in substances such as concrete.

The methods of manufacturing and the carbonated plastic aggregate of the present invention provide an environmental benefit, as the plastic aggregate sequesters CO₂ which would otherwise be released (or continue to be present) in the atmosphere; and additionally avoid the CO₂eq emissions associated with the otherwise incineration of the waste plastic-based foams. Additionally, as the carbonated plastic aggregate is intended to replace at least a part of the natural aggregate, the concrete compositions of the present invention also have an environmental benefit due to the lower environmental impact associated with sourcing the natural aggregates. Reducing the use of natural aggregates is further beneficial as the natural aggregates are becoming scarce and more costly owing to their overuse.

The carbonated plastic aggregate is mainly intended to replace at least a part of the natural aggregate used in concrete.

The concrete compositions of the present invention may be used, for instance, in the building industry to manufacture building components having similar compressional strength as incumbent blocks (as per British standard), but advantageously having lower thermal conductivities and densities.

A first aspect of the invention is a method of manufacturing a carbonated plastic aggregate comprising the steps of:
(i) mixing plastic particles and at least one cementitious binder comprising at least one metal oxide or at least one metal silicate to form a first composition,
(ii) providing a second composition comprising water;
(iii) mixing together the first and second compositions to form a pre-mixture;
(iv) agglomerating the pre-mixture to form a plastic aggregate; and
(v) carbonating the at least one metal oxide or the at least one metal silicate by means of an active carbonation process to obtain the carbonated plastic aggregate

A second aspect of the invention is a method of carbonating a plastic aggregate pellet comprising:
(i) providing a plastic aggregate pellet comprising a) a plastic particle, b) at least one cementitious binder comprising at least one metal oxide or at least one metal silicate, and c) water; and
(ii) carbonating the at least one metal oxide or at least one metal silicate by means of an active carbonation process to obtain a carbonated plastic aggregate.

A third aspect of the invention is a concrete composition comprising carbonated plastic aggregate obtainable by the methods of the first or second aspect of the invention.

### DESCRIPTION OF THE FIGURES

FIG. 1 shows the compressive strength after 2 and 7 days of curing of precast concrete in which 25% in volume of the large aggregate has been substituted with the corresponding volume of plastic aggregate pellets, plastic aggregate mix, PUR-only pellets and PUR powder.

FIG. 2 shows an example of plastic powder segregation into a concrete matrix.

FIG. 3 shows the compressive strength of GGBS based concrete over time, with the addition of sodium hydroxide, sodium carbonate or both.

FIG. 4 shows the resistance to tumbling for graphene-containing plastic aggregate.

FIG. 5 shows the compressive strength of concrete comprising graphene-plastic aggregate pellets.

FIG. 6 shows the resistance to tumbling for pigmented 4 mm aggregate pellets.

FIG. 7 shows the resistance to tumbling for pigmented 6 mm aggregate pellets.

FIG. 8 shows the resistance to tumbling for pigmented 8 mm aggregate pellets.

FIGS. 9 and 10 show the setup of concrete cubes for the sunlight exposure experiment described in Example 4.

FIG. 11 shows a diagram of an active carbonation using Flue gas/DAC.

FIG. 12 shows a diagram of a modified pellet mill that involves conducting the pelletising under a CO₂ atmosphere.

FIG. 13 shows a schematic for a modified pan pelletising under a CO₂ atmosphere.

### DETAILED DESCRIPTION OF THE INVENTION

Unless indicated otherwise, all technical and scientific terms used herein will have their common meaning as understood by one of ordinary skill in the art to which this invention pertains.

The term “comprising” or variants thereof will be understood to imply the inclusion of a stated element, integer or step, or group of elements, integers or steps, but not the exclusion of any other element, integer or step, or group of elements, integers or steps. The term “comprising” or “comprises” will include references to the component consisting essentially of (such as consisting of) the relevant features.

The term “consisting” or variants thereof is to be understood to imply the inclusion of a stated element, integer or step, or group of elements, integers or steps, and the exclusion of any other element, integer or step or group of elements, integers or steps.

The term “about” herein, when qualifying a number or value, is used to refer to values that lie within ±5% of the value specified. For example, if a particle size range is specified to be about 60 μm to about 4 mm, particle sizes of 57 μm to 4.2 mm are included.
“wt %” is a common abbreviation in the art to mean the “weight %” with respect to the total weight of the article/material referred to.
“Thermosetting polymer” refers to a polymer, which on curing, irreversibly forms an infusible, insoluble polymer network known as a thermoset.

A first aspect of the invention is a method of manufacturing a carbonated plastic aggregate comprising the steps of:
(i) mixing plastic particles and at least one cementitious binder comprising at least one metal oxide or at least one metal silicate to form a first composition,
(ii) providing a second composition comprising water;
(iii) mixing together the first and second compositions to form a pre-mixture;
(iv) agglomerating the pre-mixture to form a plastic aggregate; and
(v) carbonating the at least one metal oxide or metal silicate by means of an active carbonation process to obtain the carbonated plastic aggregate.

The term “aggregate” is used herein to refer to particulate material.

As used herein, “carbonated plastic aggregate” refers to a plastic aggregate containing increased amounts of metal carbonate species (e.g. CaCO₃ or MgCO₃) compared to the same plastic aggregate but which had not been exposed to a carbonation step. The metal carbonate species may result, for example, from reactions of oxides (e.g. calcium oxide, magnesium oxide) or silicates (calcium silicate, magnesium silicate) with carbon dioxide.

“Plastic” as used herein includes synthetic or semi-synthetic plastics, which are materials comprising polymers as a main ingredient. Semi synthetic polymers are obtained from natural polymers by chemical modification. Plastics may be classified by the chemical structure of the polymer's backbone and side chains. Important groups classified in this way include the acrylics, polyesters, silicones, polyurethanes, and halogenated plastics. Most plastics contain organic polymers.

“Plastic” as used herein includes rubbers, such as natural rubber or vulcanised rubber. Natural rubber is a polymer of isoprene (polyisoprene).

In some embodiments, the plastic used to form the plastic aggregate is a synthetic or semi-synthetic plastic, or a rubber.

In some embodiments, the plastic used to form the plastic aggregate is a synthetic or semi-synthetic plastic, preferably synthetic.

Suitably, the plastic used to form the plastic aggregate is a thermoset plastic. A thermoset plastic is obtained by irreversibly hardening (also known as “curing”) a soft solid or viscous liquid prepolymer (resin).

Suitably the plastic used to form the plastic aggregate is derived from a plastic-based foam.

As used herein, “foam” refers to a plastic-based material comprising a cell structure, such as a closed cell, an open cell structure or a mixture thereof. As a consequence of the cell structure, foams are porous materials. Porosity is inversely correlated with density. In general, foams are divided into high-, medium- and low-density foams, when considering their density. High density foams have a density between 0.5 g/cm³ and 1000 kg/m³, medium density between 100 kg/m³ and 500 kg/m³ and low density lower than 100 kg/m³. Low density foams are mainly used in insulation applications whereas medium density foams find many uses in the packaging, building and construction industry. High density foams have noticeably higher strength and modulus, and thus, can often replace regular plastics in applications where lower electrical/thermal conductivity, weight per volume, dielectric constant, compression modulus as well as greater flexibility and damping is needed or required.

Due to their porosity, foams are characterised by a high surface area. A particular advantage of using a foam in the present invention is that the higher surface area of the plastic in the plastic aggregate allows for more exposed surface comprising the metal oxide, and thus more of the metal oxide or silicate (i.e. the at least one metal oxide or silicate of the cementitious binder) is available to carbonate. In some embodiments, the plastic used to form the plastic aggregate is a foam.

“Rigid foam” refers to a plastic-based foam material which typically has a closed cell structure. The density is typically regulated by the addition of blowing agents. Typically, the density of rigid foam is up to 800 kg/m³. “Flexible foam” refers to a plastic-based material which typically has an open cell structure. Typically, the density of flexible foam is around 15 kg/m³ to 150 kg/m³. Because of the very fine cell structure of rigid and semi-rigid foams, mechanical handling like drilling, milling or grinding is possible.

Suitably, the plastic, such as the plastic-based foam, used in the present invention may be a rigid or flexible foam. Preferably the plastic-based foam is a rigid foam.

Suitably, the plastic-based foam may be a waste plastic-based foam. “Waste plastic-based foam” refers to plastic-based foam materials that have been used in a first instance, such as in appliances, insulation or furniture. The materials are then being disposed of and are not recycled. As described in the background, they would typically be incinerated or disposed of in a landfill site after their first use. Waste plastic-based foams are generally grey or yellow, beige or cream in colour, and have lower densities (between 48 and 961 kg/m³) compared to other plastics (the densities of PE, PP and PS are approximately 901 kg/m³, 895 kg/m³ and 1050 kg/m³, respectively). Waste plastic-based foams have a cellular structure (closed or open depending on rigidity), are thermoset plastics, and often contain a urethane linkage.

Most commonly used plastic foams comprise isocyanate. Polymer foams containing isocyanate monomers are referred to herein as “isocyanate-based foams”. The skilled person would be able to determine whether a given polymer contains isocyanate monomers using standard techniques known in the art. Isocyanates are compounds containing the isocyanate group (—N═C═O). They react with nucleophiles such as alcohols (containing the hydroxy group), amines or water. Upon treatment with an alcohol, an isocyanate forms a urethane linkage. If a diisocyanate is treated with a compound containing two or more hydroxyl groups, such as a diol or a polyol, polymer chains are formed, which are known as polyurethanes. Common isocyanates used in the formation of foam plastics include methylene diphenyl diisocyanate (MDI) and toluene diisocyanate (TDI).

Suitably, the plastic, such as the plastic-based foam (e.g. waste plastic-based foam) used in the present invention comprises an isocyanate-based foam, such as polyurethane (PUR), polyisocyanurate (PIR) or polyurea.

In a preferred embodiment, the plastic, such as the plastic-based foam (e.g. waste plastic-based foam) comprises polyurethane or polyisocyanurate. More preferably, the plastic, such as the plastic-based foam (e.g. waste plastic-based foam) is polyurethane.

The particles of plastic may be derived from plastic-based foam (such as waste plastic-based foam). Suitably the particles of plastic may have a size distribution of about 0.1 mm to about 6 mm, preferably about 0.2 mm to about 5 mm, such as about 0.2 mm to about 3 mm or about 0.2 mm to about 2 mm. It is to be understood that the size range given refers to the longest dimension of the particles of plastic. At least some of the particles of plastic are of sizes that fall within the size range. For example, some of the particles of plastic may have sizes of about 1 mm, and the rest of the particles of plastic may have sizes greater than about 6 mm. According to particular embodiments, substantially all (more than 90% by weight, often more than 95% by weight, for example more than 98% or 99% by weight) of the particles of plastic are of a size from of about 0.1 mm to about 6 mm, preferably about 0.2 mm to about 5 mm, more preferably about 0.2 mm to about 2 mm.

In some embodiments, the size of the particles of plastic, such as those derived from plastic-based foam (e.g. waste plastic-based foam), may be greater than about 0.1 mm, such as greater than about 0.2 mm, 0.3 mm, 0.4 mm, 0.5 mm, 0.7 mm, 0.8 mm, 0.9 mm, 1 mm, 1.5 mm, or 2 mm. In some embodiments, the size of the particles of plastic, such as those derived from plastic-based foam (e.g. waste plastic-based foam), may be less than about 6 mm, such as less than about 5.5 mm, 5 mm, 4.5 mm, 4 mm, 3.5 mm or 3 mm. For the avoidance of doubt, any of the aforementioned lower range end-points may be combined with any of the aforementioned upper range end-points.

“Cementitious binder” refers to a material or substance that adheres other materials together to form, set and harden the resulting concrete composition. “Cementitious binder” encompasses cement, a slag (such as ground granulated blast furnace slag (GGBS)), pulverised fly ash (also known as pulverised fuel ash), Portland cement, pozzolanic material or geopolymers.

Often, the cement comprises any one or a mixture of calcium oxide, calcium hydroxide and calcium silicate. Typically, the cement is a hydraulic cement such as Portland cement, which reacts with water via Pozzolanic reactions to cure and set. Portland cement is usually made by heating limestone and clay minerals to form a clinker, which is ground and contacted with gypsum. Portland cement typically consists of at least two-thirds by mass of calcium silicates, with the remainder consisting of aluminium- and iron-containing compounds. The ratio of CaO to SiO₂ within Portland cement is at least 2:1.

“Geopolymers” are amorphous, alumina-silicate binder materials. “Geopolymers” encompass metakaolin.

The at least one cementitious binder comprises at least one metal oxide or metal silicate. In some embodiments, the at least one cementitious binder comprises at least one metal oxide.

Suitably, the cementitious binder may comprise cement (such as Portland cement and/or High Strength Cement (HSC)), a slag (such as ground granulated blast furnace slag (GGBS)), fly ash (also known as pulverised fuel ash), pozzolans, geopolymers, or a mixture of two of more thereof. In one embodiment, the cementitious binder may comprise cement and/or a slag (such as GGBS). Preferably, the cementitious binder comprises a slag (such as GGBS), more preferably GGBS.

In alternative embodiments, the cementitious binder comprises cement. In one embodiment, the cement comprises Portland cement.

The preferred binder GGBS represents a lower carbon alternative to Ordinary Portland Cement (OPC). The use of GGBS allows to reduce the embodied carbon of the aggregate and of the final concrete, compared to the use of OPC. GGBS is characterised by an extremely slow curing rate when hydrated and is typically activated by an alkaline solution which increases the curing rate and compressional strengths.

Although the slow curing rate of GGBS could represent an obstacle, during the production of the composite aggregate (such as via pelletisation, which generates high pressure and heat), the pressure and heat improves the aggregates strength due to compaction of the particle.

The pre-mixture is agglomerated to form a plastic aggregate. “Agglomeration” refers to the process of accumulating material into larger cohesive units. Suitably the agglomerating comprises pressure or non-pressure agglomeration of the pre-mixture to form the plastic aggregate.

In some embodiments, the agglomeration comprises compressing and heating. As such, the pre-mixture may be compressed and heated to form the plastic aggregate.

Compressing plastic powders into coarser particles improves the performance of plastic in uses such as concrete. The larger particles will present a lower surface area in contact with the concrete matrix, reducing the weakening effect of the unfavourable contact between the two. The larger plastic particles, however, will still tend to segregate, even if in a lower extent compared to the powder, and will still constitute zones of weaker material within the concrete matrix due to no connectivity between the powder PUR in the larger particles.

In the present invention, the plastic (e.g. PUR plastic) is agglomerated (e.g. compressed) into larger particles and held together by a cementitious binder and water. Without wishing to be bound by theory, it is believed that the larger particles will have a lower contact surface area with the concrete matrix but also the presence of the binder will improve the interfacial interaction between the aggregate and the cement matrix due to being similar or the same materials. The effect of the cementitious binder, which will cure in contact with water in the pre-mixture, also causes a general strengthening of the plastic aggregate, reducing the general weakening effect of plastic only (e.g. PUR-only) pellets on the final concrete matrix.

Compression is achieved by applying a force to the powdered mixture to combine it. Heat might be generated from the compression process or heat may be applied after the formation of the aggregate by compression.

Suitably, compression and heating may be a single process. Preferably, the agglomerating, such as the compression, and optionally the heating, comprises pelletisation. Typically, during certain compression methods, including pelletisation, the heating required is generated naturally from friction during the compression of the mixture being pushed through the die. However, further heating can also be applied after compression to keep the pellets warm for longer to further increase the curing speed.

“Pelletisation” is the process of compressing material into the form of a pellet. Suitably the pelletisation is die mill pelletisation, pan pelletisation, briquetting or extrusion pelletisation. Die mill pelletisation refers to converting finely ground material into free flowing pellets. “Pan pelletisation” refers to mixing material (e.g. finely ground material or seed pellets) with a binder and agitating the resulting mixture until pellets of desired size have formed. The centrifugal force experienced by the pellets against the edge of the pelletiser creates compression of the particles into a pellet. In addition, continually rotating and falling would compress and increase the density the pellets each time the aggregate falls while rotating round the pan. “Briquetting” refers to compressing material into a desired form, such as a pellet. “Extrusion pelletising” (also referred to as “compounding”) refers to extruding a mixture, then passing the mixture onto a pelletiser such as a granulator to convert the extrudate into pellets.

Preferably, the pelletisation is die mill pelletisation.

Alternatively, compression and heating may be separate, so that they are carried out as part of separate processes, and/or are carried out at different locations or a different time. In such cases, compression is first carried out, followed by heating. Therefore, in some embodiments, compression and heating are separate processes, wherein compression is carried out before heating. Heat is required to increase the curing of the pellets.

The plastic aggregate is exposed to an active carbonation process to obtain the carbonated plastic aggregate.

As used herein, “active carbonation” refers to a carbonation process wherein the rate of carbonation is increased compared to the “passive carbonation rate”. Passive carbonation of the plastic aggregate refers to carbonation by exposing the plastic aggregate to ambient conditions (which atmosphere comprises around 420 ppm CO₂). As such, the passive carbonation rate is the rate of carbonation of the plastic aggregate exposed only to ambient conditions, i.e., without increasing the concentration of CO₂ in the surrounding atmosphere, without heating, or watering, etc.

Suitably, the active carbonation process may comprise adding water to the cementitious binder or the plastic aggregate, such as using manual watering, automatic spray systems or exposing the plastic aggregate to rain. Watering the aggregate increases the carbonation reaction rate.

Suitably, the active carbonation process may comprise heating the plastic aggregate, such as by using heating elements or a heat exchange system. Heating the plastic aggregate increases the carbonation reaction rate.

Intentionally increasing the airflow throughout the aggregate, particularly while exposing the aggregate to an atmosphere comprising CO₂, increases the rate of carbonation, and is thus an “active carbonation” process. In some embodiments, the active carbonation comprises increasing the airflow throughout the plastic aggregate, such as by placing the aggregate on a raised false floor. In some particular embodiments, increasing the airflow throughout the plastic aggregate may be combined with a heat exchange system whereby waste heat from industrial processed in a gas or water form could be channeled through a pipe that is in conduct with the airflow. This extra heat would increase the carbonation rate. In some embodiments, the active carbonation comprises increasing the airflow throughout the aggregate and exposing the plastic aggregate to an atmosphere comprising increased CO₂ concentration (i.e., higher concentrations of CO₂ versus the typical ambient atmosphere, such as to more than 450 ppm).

All equipment used in the watering, heating or increasing the airflow processes may be ran using renewable electricity sources and energy plans as to not damage the environment more than the aggregate would remove from the atmosphere.

“Active carbonation” may also refer to exposing the plastic (such as the plastic aggregate) to a CO₂ enriched source. A CO₂ enriched source refers to a source of air comprising a higher concentration of CO₂ than that found in the atmosphere (i.e. more than approximately 420 ppm), such as at least 450 ppm. Such a CO₂ enriched source may be captured flue gases from places such as power plants, cement kilns and chemical manufacturing. Suitably the CO₂ enriched source has a CO₂ concentration of or higher than 0.5% higher than the CO₂ concentration of the atmosphere, preferably of or higher than 1%, more preferably 2%, 5%, 10%, 20%, 30%, 40%, 50%, 60%, 70%, 80%, 90%, 95%, 99% or 100% higher than the CO₂ concentration of the atmosphere.

In some embodiments, the source of CO₂ has a concentration of at least 0.05%, 0.5%, 1%, 2%, 5%, 10%, 20%, 30%, 40%, 50%, 60%, 70%, 80%, 90%, 95%, 99% or 100% of CO₂.

“Active carbonation” may also refer to direct air capture (DAC) whereby the CO₂ is extracted directly from the atmosphere (FIG. 11). Once pulled from the atmosphere, permanent storage would be required to stop CO₂ leaking back into the environment. Carbonation of the plastic aggregate may be used to store this CO₂. As such, in some embodiments, the active carbonation process comprises direct air capture (DAC).

In some embodiments, active carbonation comprises the use of a reaction chamber whereby the source of CO₂ is pumped into a vessel containing the plastic aggregate. The temperature, pressure and moisture inside the reaction chamber may be controlled. In some embodiments, the plastic aggregate in the vessel has already hardened after production. Alternatively, the plastic aggregate could be introduced in the vessel as soon as the plastic aggregate has been formed, such as from compression pelletising or pan pelletising.

Once the plastic aggregate is produced, it could be conveyed using a sealed system comprising an enriched CO₂ atmosphere. The sealed system may be an enclosed belt conveyor or a vibrating spiral conveyor.

One or more of the aforementioned “active carbonation” processes may be used in the methods of the present invention, sequentially or simultaneously.

The agglomerating and carbonating steps are simultaneous or sequential in any order. In some embodiments, the compressing, heating and carbonating steps are simultaneous or sequential in any order.

As such, the active carbonation step may be performed before the formation of the aggregate (i.e., before the agglomeration step, such as compressing or heating steps, i.e., during step (iii) and/or between step (iii) and (iv)), during the formation of the aggregate (i.e. during the agglomeration step, such as compressing or heating steps), as soon as the plastic aggregate is formed (i.e. as a sequential step after agglomerating, such as after the compressing and heating), and/or once the plastic aggregate has hardened, such as after a couple of days.

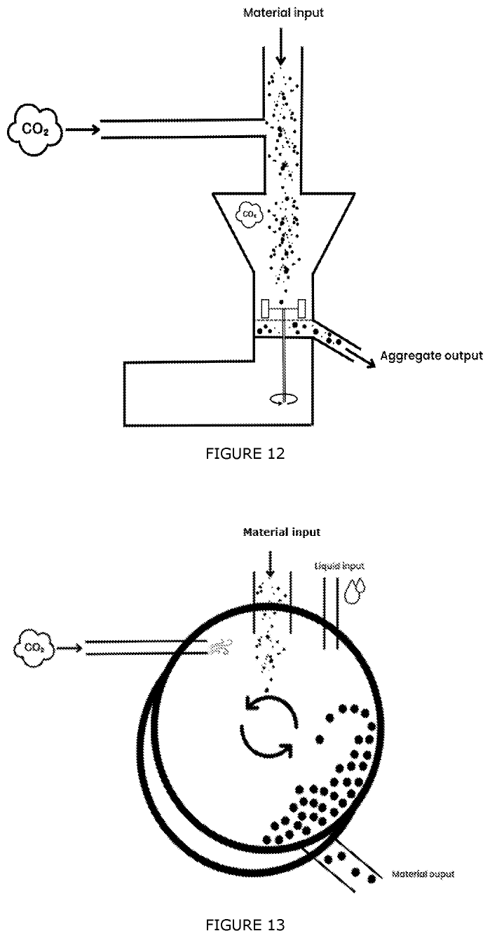

In some embodiments, the agglomerating and carbonating steps are simultaneous. As such, in some embodiments, the method comprises making the plastic aggregate in step (iv) under a CO₂ atmosphere (either at ambient temperature and pressure or at elevated temperatures and pressures) to result directly into a carbonated plastic aggregate. FIG. 12 shows a diagram of a modified pellet mill that involves conducting the pelletising under a CO₂ atmosphere.

In embodiments wherein the agglomeration comprises compressing and heating, the compression and active carbonation (and optionally the heating) steps may be carried out simultaneously.

The carbonated plastic aggregate may then be fed into a pellet mill to pelletise the carbonated plastic aggregate. An advantage of this process is that heat is generated from the compression of the plastic aggregate which would accelerate the carbonation process.

Suitably, the plastic aggregate is tumbled around a pan pelletiser which has been modified to be sealed from the atmosphere, to form an aggregate (e.g. spherical aggregate) under a CO₂ atmosphere (FIG. 13). The carbonation is accelerated in this process.

Water absorption is important for the carbonation process. As such, in embodiments where the plastic aggregate comprises plastic foam (such as waste plastic foam), the carbonation process is particularly efficient, because the aggregate is able to absorb large amounts of water due to a network of pores, which aids the carbonation process as a larger amount of absorbed water would be able to absorb more CO₂ into carbonic acid for the carbonation process.

The carbonation process is directly related to surface area. As the plastic aggregate described herein is porous (particularly in embodiments wherein the plastic used to form the aggregate is a plastic-based foam), it allows for a higher surface area and thus exposing more of the metal oxide or silicate of the cementitious binder, and so aiding in the carbonation of the plastic aggregate.

Additionally, without wishing to be bound by theory, in embodiments where sodium hydroxide is used as an inorganic base, the NaOH is expected to react with the carbonic acid to create sodium bicarbonate. According to Iversen et al (ACS Applied Materials & Interfaces 2015 7 (9), 5258-5264), sodium bicarbonate is able to act as a catalyst for the carbonation of magnesium silicates.

As such, in some embodiments, the method may comprise adding a catalyst to the pre-mixture or the plastic aggregate that is able to increase the carbonation rate of the aggregate (such as sodium bicarbonate).

Without wishing to be bound by theory, the plastic aggregate as described herein is believed to exhibit an increased carbonation rate due to the use of plastic. Carbon dioxide is hydrophobic and the concentration of CO₂ at the surface of a plastic is expected to be higher due to the hydrophobic nature of the plastic. This could then lead to a higher concentration of CO₂ at the water/air interface, increasing the dissolution rate of the CO₂ and resulting in faster carbonation.

Suitably, in embodiments wherein the plastic used to form the plastic aggregate is waste plastic-based foam, the method of the invention may further comprise the following pre-step:
(i). receiving the waste plastic-based foam such as from a recycler or manufacturer.

The waste plastic-based foam in pre-step (i) may be received in the form of pellets, powders, panels or briquettes. Preferably, the waste plastic-based foam is received in the form of pellets or powders.

In one embodiment, the waste-plastic based foam may be contaminated with demolition rubble. For example, the waste-plastic based foam in pre-step step (i) may be received in the form of pellets, powders, panels or briquettes and said pellets, powders, panels or briquettes are mixed with demolition rubble or comprise demolition rubble. Suitably, the method may comprise an additional pre step (i-a) of separating the plastic-based foam from said demolition rubble.

In some embodiments, the second composition further comprises at least one inorganic base. Early strength and final strength can be improved by the use of an activator solution, preferably obtained by adding sodium hydroxide, sodium carbonate, calcium oxide or a combination thereof. A secondary advantage of this process is when scaled up (>0.5 T), the aggregate can retain the heat generated by the process and the heat generated through the hydration reaction for multiple days, this is due to the inherent insulating properties of the plastic (e.g. PUR), this causes improved compressional strengths.

The “inorganic base” acts as an activator. Inorganic bases include a class of inorganic compounds with the ability to react with, that is neutralize, acids to form salts. These compounds comprise strong and weak bases, such as metal hydroxides, alkali metal hydroxides, ammonium hydroxides, alkali metal carbonates or bicarbonates. The term is intended to comprise also substances that can generate bases, i.e. hydroxides, when in contact with water, such as metal and alkali metal oxides, alkaline silicates.

Suitably, the at least one inorganic base comprises an alkali hydroxide, alkali oxide, alkali carbonate, alkaline silicates or a mixture thereof. In some embodiments, the alkali is sodium, potassium or calcium.

Preferably the at least one inorganic base comprises sodium hydroxide, sodium carbonate, calcium oxide, or a mixture thereof.

Additionally, it has been found by the inventors that unreacted inorganic base in the plastic aggregate diffuses out when combined with particular cementitious binders (for example, GGBS) to form the concrete composition or the concrete block. This diffused inorganic base significantly speeds up the curing of the particular cementitious binders (for example, GGBS) resulting in a harder concrete quicker. This is beneficial as some cementitious binders (for example, GGBS) are known in the industry to take a long time to cure, which results in slow and impractical manufacturing. As such, the method may further comprise the step of mixing the carbonated plastic aggregate with at least one cementitious binder to form a concrete composition. Preferably the at least one cementitious binder comprises GBBS. The at least one cementitious binder may be a mixture of GGBS and cement.

In some aspects of the method, when particular cementitious binders are used, an inorganic base is not required to cure the binder. As such, suitably there is provided a method that does not require an inorganic base in step ii and the second composition. Exemplary cementitious binders include Portland cement.

In some embodiments, the carbonated plastic aggregate is in the form of a pellet.

The width of the carbonated plastic aggregate pellet may be 0.05 to 10 mm, preferably 0.5 to 10 mm, such as 1 to 9 mm, 2 to 8 mm, 2 to 7 mm, 2 to 6 mm or 2 to 5 mm, preferably 2 to 8 mm. The length of the carbonated plastic aggregate pellet may be 0.5 to 10 mm, such as 1 to 9 mm, 2 to 8 mm, 2 to 7 mm, 2 to 6 mm or 2 to 5 mm, preferably 2 to 8 mm.

An “aspect ratio” is a well-known ratio and is a proportional relationship between the aggregate's length and width. The aspect ratio between the length of the pellet and the width of the pellet may be 0.05 to 20, such as 0.1 to 10, 0.2 to 8, 0.25 to 6, 0.25 to 4, preferably 0.25 to 4. Suitably the carbonated plastic aggregate is round and therefore it can be difficult to distinguish between length and width. Thus suitably the aspect ratio is about 1:1.

The ratio between the plastic to cementitious binder is important to achieve the desired strength and density of the resulting aggregate. In some embodiments, the weight ratio of plastic to cementitious binder in the pre-mixture and/or plastic aggregate and/or carbonated plastic aggregate is from 2:1 to 1:10, such as 2:1 to 1:7, 1:1 to 1:5 or 1:1 to 1:4, preferably 2:1 to 1:7.

The amount of water is important for achieving hydration of the cementitious binder and to aid in the pelletisation process. If the amount of water is too high, the resulting mixture will not process efficiently and if the amount of water is too low, the mixture can get stuck in the die and not be processed properly. In some embodiments, the weight ratio of water to cementitious binder in the pre-mixture and/or the plastic aggregate and/or the carbonated plastic aggregate is from 0.1 to 1, such as 0.2 to 0.6 or 0.3 to 0.5, preferably 0.3 to 0.5.

In some embodiments, the amount of inorganic base is important for activating the hydration of the cementitious binder and to achieve a higher final strength of the resulting pellets. In some embodiments, the weight % of inorganic base in the pre-mixture and/or the plastic aggregate and/or the carbonated plastic aggregate is from 0 to 15% w/w of the cementitious binder, 0.1 to 15% w/w of the cementitious binder, such as 0.5 to 12% w/w, 1 to 10% w/w, or 2 to 10% w/w, preferably 2 to 10% w/w of the cementitious binder.

The strength of the carbonated plastic aggregate and the resulting concrete may be increased using strength enhancers. In some embodiments, the method further comprises the step of adding a strength enhancer (preferably graphene) during or between any one of steps (i), (ii) or (iii). In particular embodiments, the strength enhancer (preferably graphene) is added to the first composition during or after step (i), preferably after step (ii) and before step (iii).

The carbonated plastic aggregate may be coloured using pigments. In some embodiments, the method further comprises the step of adding a pigment during or between any one of steps (i), (ii) or (iii). In particular embodiments, the pigment is added to the first composition during or after step (i), preferably after step (i) and before step (iii).

Fillers may improve the properties and the microstructure of concrete. In some embodiments, the method further comprises the step of adding a filler during or between any one of steps (i), (ii) or (iii), preferably wherein the filler is limestone and/or clay and/or microsilica. In particular embodiments, the filler is added to the first composition during or after step (i), preferably after step (i) and before step (iii).

Suitably, the method of the invention may further comprise the following pre-steps:
(ii). Granulating the plastic (such as the plastic-based foam or the waste plastic-based foam) to form a mixture of plastic particles; and/or
(iii). Sieving the mixture to size separate the plastic particles;

Suitably, a mixture of plastic particles according to step (ii) may be produced by granulating waste plastic-based foam of larger size. It is to be understood that plastic-based foam of larger size refers to bulk plastic, i.e. large pieces of plastic-based foam such as rigid or flexible foam sheeting, as well as plastic foam particles that are of larger size than the desired size of the plastic aggregate particles.

The term “granulating” refers to forming into particles, i.e. discrete, solid pieces, and may be achieved by shredding (tearing or cutting), milling (pressing, crushing and/or grinding) and chipping (breaking off pieces).

Granulating may be achieved by any method that reduces the size of the plastic of larger size and forms it into the desired smaller particles. Granulating may be carried out by any one or a combination of methods selected from shredding, milling and chipping. In some embodiments, granulating comprises shredding. In other embodiments, granulating comprises shredding and milling. Typically, granulating comprises shredding followed by milling. The surface texture of the plastic particles following granulation is dependent on the method used to granulate the plastic of larger size. Rougher surfaces are reported to produce better adhesive properties, thus granulating methods that produce more textured surfaces are preferred. Typically, excessive milling of the plastic of larger size is avoided as it may smooth the surfaces of the resulting particles to an undesirable extent.

In some embodiments, the mixture is sieved to size separate the plastic particles. The plastic particles are separated by size using particle sieves of different mesh size. The skilled person is able to determine which mesh sizes are appropriate to use for the size range covered by one size category. For example, if it is preferable to separate the plastic particles by longest dimension into size categories of <63 μm, >63 μm to <125 μm, >125 μm to <250 μm, >250 μm to <500 μm, >500 μm to <2 mm, >2 mm to <4 mm, >4 mm to <6 mm, >6 mm to <10 mm, >10 mm to <20 mm, >20 mm to <40 mm then mesh sizes of No. 230, 120, 60, 35, 10, 5 should be used. The plastic particles may be separated by sieving in order of increasing or decreasing mesh size. Typically, the plastic particles are separated by sieving through particle sieves of decreasing mesh size (increasing mesh size No.).

Suitably, the plastic particles of different sizes may be contacted with one another. Usually, contacting entails combining and often mixing the particles. Herein, particles are to be regarded as being of different sizes when their longest dimensions differ by more than 5%.

For example, if a first particle has a longest dimension of 0.5 mm and a second particle has a longest dimension of 0.48 mm, the two particles differ in longest dimension by 5% or less, and are considered herein to be of similar sizes. Conversely, if a first particle has a longest dimension of 0.5 mm and a second particle has a longest dimension of 0.53 mm, the two particles differ in longest dimension by more than 5%, and are considered herein to be of different sizes.

In one embodiment, the carbonated plastic aggregate has a size distribution of 0 mm to about 2 mm, preferably 0 mm to about 1 mm. Preferably, the carbonated plastic aggregate is in the form of powder. It is to be understood that the size range given refers to the longest dimension of the plastic particles. At least some of the particles of the aggregate are of sizes that fall within the size range. For example, some of the particles of the aggregate may have sizes of about 1 mm, and the rest of the particles of the aggregate may have sizes greater than about 2 mm. According to particular embodiments, substantially all (more than 90% by weight, often more than 95% by weight, for example more than 98% or 99% by weight) of the plastic particles in the carbonated aggregate are of a size from about 0 mm to about 2 mm, or 0 mm to about 1 mm.

In one embodiment, the carbonated plastic aggregate has a size distribution of about 2 mm to about 40 mm, preferably about 5 mm to about 10 mm. Preferably, the carbonated plastic aggregate is in the form of pellets. It is to be understood that the size range given refers to the longest dimension of the plastic particles. At least some of the particles of the aggregate are of sizes that fall within the size range. For example, some of the particles of the aggregate may have sizes of about 2 mm, and the rest of the particles of the aggregate may have sizes greater than about 40 mm. According to particular embodiments, substantially all (more than 90% by weight, often more than 95% by weight, for example more than 98% or 99% by weight) of the plastic particles in the carbonated aggregate are of a size from of about 2 mm to about 400 mm, or 5 mm to about 10 mm.

Suitably, the method may comprise the step of adding at least one additive, such as before step (iv). The resulting carbonated plastic aggregate would comprise the at least one additive.

Additives include admixture, strength enhancers, rheology modifier, pigment, fibre, or a mineral.

“Admixture” encompasses materials such as air entrainers, water reducers, set retarders, set accelerators or plasticisers. Admixture includes rosin resin, alkyl sulfonate, aliphatic alcohol sulfonate, protein salt and petroleum sulfonate, soluble inorganic salts of alkali and alkali earth metals (sodium or potassium hydroxide, calcium chloride, bromide and fluoride, sodium and calcium nitrite and nitrate, potassium carbonate, sodium and calcium thiocyanate, sulphate, thiosulphate, perchlorate, silicate, aluminate), carboxylic acids (formic, acetic, propionic and butyric, oxalic) and their salts (Calcium formate, calcium oxalate), lignosulfonates, sulfonated naphthalene formaldehyde (PNS), sulfonated melamine formaldehyde (PMS), vinyl copolymers (VCPs), and polycarboxylic ethers (PCEs). Suitably, the method may comprise the step of adding at least one admixture, such as before step (iv).

“Strength enhancers” are materials used to increase the strength of the concrete. Strength enhancers include graphene and alkanolamines for example tri-isopropanolamine (TIPA) and Triethanolamine (TEA). Suitably, the at least one additive comprises a strength enhancer. Suitably, the method may comprise the step of adding at least one strength enhancer, such as before step (iv).

In some embodiments, the strength enhancer is graphene. Graphene increases the strength of the plastic aggregate and the strength of the resulting concrete comprising the plastic aggregate. Graphene can be functionalised with surface groups (such as graphene oxide and other forms of functionalised graphene), dispersed in a liquid using a surfactant or used without any dispersion aids, just the pure carbon form.

Modifying the rheological properties of concrete may improve the properties of concrete in the fresh and hardened state, which is particularly important for production and placement of special construction applications such as underwater or self-consolidating concrete. A “rheology modifier” is a material that alters the rheology (i.e. deformation or flowing response to applied forces or stresses) of a fluid composition to which it is added. Rheology modifiers include viscosity modifying agents such as cellulose ethers, natural gums (xanthan, wellan) and starch. Suitably, the method may comprise the step of adding at least one rheology modifier, such as before step (iv).

Cement may be coloured using pigments. A “pigment” is a coloured material that is completely or nearly insoluble in water. Pigments include iron oxide, cobalt, titanium dioxide and chromium oxide pigments and carbon black. Suitably, the method may comprise the step of adding at least one pigment, such as before step (iv).

Fibre-reinforced concrete has greater tensile strength when compared to non-reinforced concrete. Fibers include cellulose fibres, natural fibres, carbon fibres, polyester fibres, glass fibres, polypropylene fibres, and steel fibres. Suitably, the method may comprise the step of adding at least one fibre, such as before step (iv).

In some embodiments, the method may comprise the step of adding at least one additive, such that the pre-mixture and/or the carbonated plastic aggregate comprises from 0.01 to 5 wt % of the at least one additive, such as 0.1 to 5 wt %, 0.1 to 3 wt %, or 1 to 3 wt %.

Fillers may improve the properties and the microstructure of concrete. Suitably, the method may comprise the step of adding at least one filler, such as before step (iv). The filler may be gypsum, limestone, sand, wood, wood shavings, clay, concrete dust, microsilica, or char, preferably clay, limestone, microsilica or a mixture thereof, preferably clay.

In some embodiments, the clay is calcined clay. The calcined clay may be natural or synthetically produced by high temperature kilns.

In particular embodiments, the method may comprise the step of adding calcined clay, such as before step (iv) and the cementitious binder comprises high strength cement. In particular such embodiments, the plastic aggregate further comprises a large aggregate, preferably limestone.

In some embodiments, the method may comprise the step of adding at least one filler, such that the pre-mixture and/or the carbonated plastic aggregate comprises from 0.01 to 40 wt % of the at least one filler, such as from 0.1 to 30 wt %, 0.1 to 25 wt %, 0.5 to 20 wt %, 1 to 20 wt %, or 1 to 10 wt %.

As porosity and water absorption are believed to be important for aiding the carbonation, the method may comprise adding a further material (such as before step (iv)) to allow for higher porosity and water absorption.

The further material may be a filler such as biochar.

The further material may also be a mineral, such as a ground mineral. In some embodiments, the mineral comprises high quantities of calcium and magnesium oxides and silicates.

In some embodiments, the mineral may be selected from: Oxides, Portlandite, Brucite, Silicates, Periclase, Silicates.

The minerals can be mined and ground down to a powder or sand to increase their surface area.

In a second aspect of the invention, there is provided a method of carbonating a plastic aggregate pellet comprising:
i. providing a plastic aggregate pellet comprising a) a plastic particle, b) at least one cementitious binder comprising at least one metal oxide or at least one metal silicate, and c) water,
ii. carbonating the at least one metal oxide or at least one metal silicate by means of an active carbonation process to obtain the carbonated plastic aggregate.

For the avoidance of doubt, the method of the second aspect of the invention may comprise any of the features described above for the first aspect of the invention.

For example, in some embodiments, the plastic aggregate pellet further comprises an inorganic base.

In a third aspect of the invention there is provided a concrete composition comprising the carbonated plastic aggregate obtainable, such as obtained, by a method of the first or second aspects of the invention. For the avoidance of doubt, the concrete composition may comprise any of the features described above for the first aspect or second third aspect of the invention.

Suitably, the concrete composition may further comprise a cementitious binder, a natural aggregate and/or water. Suitably, the concrete composition may further comprise a secondary aggregate.

Suitably, the concrete composition may be used to produce a concrete building component. The concrete building component may be a precast concrete component, such as a column, beam, slab or block. Preferably, the concrete building component is a concrete block.

In some embodiments, the concrete composition comprises a strength enhancer, preferably wherein the strength enhancer is graphene. The strength enhancer may be present within the concrete composition by virtue of the concrete composition comprising a plastic aggregate comprising said strength enhancer.

Suitably, the concrete composition may have a carbon footprint of −0.5 to 0.2 kg CO₂ eq per kg of concrete composition, preferably-0.35 to 0.05 kg CO₂ eq per kg of concrete composition. The skilled person would be able to determine the carbon footprint of a given composition using standard techniques known in the art, such as by carrying out an industry standard life-cycle assessment (LCA) and using Environmental Product Declarations (EPDs).

Suitably, the concrete composition may have a thermal conductivity of 0.1 to 1 W/mK, preferably 0.2 to 0.8 W/mK, more preferably 0.3 to 0.5 W/mK. Alternatively, the concrete composition may have a thermal conductivity of 0.5 to 1.6 W/mK, preferably 0.6 to 1.4 W/mK, more preferably 0.7 to 1.2 W/mK. The thermal conductivity may be measured using standard techniques known in the art, such as using thermal conductivity meters.

Suitably, the concrete composition may have a compressional strength of 1 to 60 N/mm², preferably 3 to 40 N/mm², more preferably 3.6 to 22.5 N/mm².

Suitably, the concrete composition may have a density of 600 to 2500 kg/m³, preferably 1200 to 1600 kg/m³, more preferably 1350 to 1550 kg/m³. Alternatively, the concrete composition may have a density of 1500 to 2500 kg/m³, preferably 1600 to 2200 kg/m³, more preferably 1700 to 2100 kg/m³. The density may be recorded using standard techniques known in the art, such as the British Standard, which involves drying the concrete composition and weighing it.

Plastic particles within the carbonated plastic aggregate may be surface-modified to improve interaction of the aggregate with cement. Surface modification may be achieved by exposing the particles to chemicals, gamma irradiation, electron beams or plasma. Surface modification via chemical treatment typically results in the binding of new chemical groups at the surface of the particle.

Atmospheric plasma treatment is limited to ionising chemicals that are gases at atmospheric pressures, which in turn limits the types of plasma generated. Low-pressure plasma treatments may be used as an alternative. In low-pressure plasma treatments, a reaction chamber is evacuated to pressures lower than atmospheric pressure, at which pressures the plasma source of interest becomes gaseous. The plasma source is ionised to produce a flow of low pressure plasma through the chamber (A. Yáñez-Pacios and J. Martín-Martínez, supra; L. Gerenser, J. Adhesion Sci. Technol., 1987, 1 (4), 303-318; L. Gerenser, J, Adhesion Sci. Technol., 1993, 7 (10), 597-614; R. Foerch, J. Izawa and G. Spears, J. Adhesion Sci. Technol., 1991, 5 (7), 549-564; and E. Occhiello et al., J. Appl. Polym. Sci., 1991, 42 (2), 551-559).

Suitably, the plastic aggregate may comprise plastics particles that have been treated with low pressure plasma or electron beam. In one embodiment, the carbonated plastic aggregate comprises plastic particles that have been treated with low pressure plasma. As described above, the low-pressure plasma is able to react with and bind to the surface of plastic. In an alternative embodiment, the plastic aggregate comprises plastic particles that have been treated with an electron beam.

In a specific embodiment, the plastic aggregate comprises plastics particles that have been treated with low pressure plasma, wherein the plasma comprises ions formed from any one or a combination selected from the group consisting of a carboxylic acid, alcohol, amine, ester, aldehyde, amide, ketone, epoxide, ammonia and peroxide.

In specific embodiments, the plastic aggregate is untreated (such as substantially untreated). As used herein, “untreated plastic aggregate” refers to plastic aggregate that has not been treated with plasma, electron beam, and/or inorganic compounds. In particular embodiments, the plastic aggregate has not been treated with inorganic compounds.

### CLAUSES

1. A method of manufacturing a carbonated plastic aggregate comprising the steps of:
(i) mixing plastic particles and at least one cementitious binder comprising at least one metal oxide or metal silicate to form a first composition;
(ii) providing a second composition comprising water;
(iii) mixing together the first and second compositions to form a pre-mixture;
(iv) agglomerating the pre-mixture to form a plastic aggregate; and
(v) carbonating the at least one metal oxide or metal silicate by means of an active carbonation process to obtain the carbonated plastic aggregate.
2. A method of clause 1, wherein the agglomerating comprises pressure or non-pressure agglomeration of the pre-mixture to form the plastic aggregate.
3. A method of clause 1 or 2, wherein the agglomerating comprises compressing and heating the pre-mixture.
4. A method of any one of the preceding clauses, wherein the agglomerating comprises briquetting or pelletisation of the pre-mixture, preferably die mill pelletisation, pan pelletisation or extrusion pelletisation of the pre-mixture.
5. The method of any one of the preceding clauses, wherein the agglomerating and carbonating steps are simultaneous.
6. A method of any one of the preceding clauses, wherein the active carbonation process comprises adding water to the cementitious binder or plastic aggregate (such as by manual watering, automatic spray systems or exposing the plastic aggregate to rain).
7. A method of any one of the preceding clauses, wherein the active carbonation process comprises providing an increased airflow through the plastic aggregate.
8. A method of any one of the preceding clauses, wherein the active carbonation process comprises heating the plastic aggregate.
9. A method of any one of the preceding clauses, wherein the active carbonation process comprises exposing the plastic aggregate to a CO₂ enriched source of gas.
10. A method of clause 9, wherein the CO₂ enriched source is obtained by direct air capture.
11. A method of clause 9, wherein the CO₂ enriched source is an industrial flue gas.
12. A method of any one of the preceding clauses, wherein the second composition further comprises at least one inorganic base.
13. A method of any one of the preceding clauses, wherein the particles of the plastic have a size distribution between 0.1 to 6 mm, preferably 0.2 to 5 mm, more preferably 0.2 to 4 mm, even more preferably 0.2 to 3 mm, yet more preferably 0.2 to 2 mm.
14. A method of any one of the preceding clauses, wherein the at least one cementitious binder is selected from GGBS, cement or fly ash, Portland cement, or a mixture thereof, preferably GGBS.
15. A method of clauses 12 to 14, wherein the at least one inorganic base comprises an alkali hydroxide, alkali oxide or alkali carbonate or a mixture thereof, preferably sodium hydroxide, sodium carbonate, calcium oxide or a mixture thereof.
16. A method according to any one of the preceding clauses, wherein the carbonated plastic aggregate is in the form of a pellet.
17. A method of clause 16, wherein the width of the carbonated plastic aggregate pellet is 0.05 to 10 mm, preferably 0.06 to 8 mm.
18. A method of clause 16 or 17, wherein the aspect ratio between the length of the pellet and the width of the pellet is 0.05 to 20, preferably 0.25 to 4.
19. A method according to any one of the preceding clauses, wherein the plastic is a synthetic or semi-synthetic plastic, or a rubber, preferably synthetic or semi-synthetic plastic, more preferably a synthetic plastic.
20. A method according to any preceding clause, wherein the plastic is derived from plastic-based foam, preferably the plastic-based foam comprises polyurethane (PUR) or polyisocyanurate (PIR), preferably PUR.
21. A method according to any preceding clause, wherein the plastic is derived from waste plastic, such as waste plastic-based foam.
22. A method according to any preceding clause, wherein the weight ratio of plastic to cementitious binder in the pre-mixture and/or the plastic aggregate is from 2:1 to 1:7.
23. A method according to any preceding clause, wherein the weight ratio of water to cementitious binder in the pre-mixture and/or the plastic aggregate is from 0.2 to 0.6, preferably 0.3 to 0.5.
24. A method according to any one of clauses 12 to 23, wherein the weight % of inorganic base in the pre-mixture and/or the plastic aggregate is from 0.1 to 15% w/w of the cementitious binder, preferably 2 to 10% w/w of the cementitious binder.
25. A method according to any preceding clause, further comprising the step of adding an additive preferably a mineral, during or between any one of steps (i), (ii) or (iii).
26. A method according to clause 25, wherein the additive is added to the first composition during or after step (i), preferably after step (ii) and before step (iii).
27. A method according to any preceding clause, further comprising the step of adding a pigment during or between any one of steps (i), (ii) or (iii).
28. A method according to clause 27, wherein the pigment is added to the first composition during or after step (i), preferably after step (i) and before step (iii).
29. A method according to any preceding clause, further comprising the step of adding a filler during or between any one of steps (i), (ii) or (iii), preferably wherein the filler is limestone and/or calcined clay and/or microsilica.
30. A method according to clause 29, wherein the filler is added to the first composition during or after step (i), preferably after step (i) and before step (iii).
31. A method of carbonating a plastic aggregate pellet comprising:
i. providing a plastic aggregate pellet comprising a) a plastic particle, b) at least one cementitious binder comprising at least one metal oxide or at least one metal silicate, and c) water,
ii. carbonating the at least one metal oxide or at least one metal silicate by means of an active carbonation process to obtain the carbonated plastic aggregate.
32. A method according to clause 31, wherein the weight ratio of plastic to cementitious binder is from 2:1 to 1:7.
33. A method according to clause 31 or 32, wherein the particles of the plastic have a size distribution between 0.2 to 5 mm, preferably 0.2 to 4 mm, more preferably 0.2 to 3 mm, even more preferably 0.2 to 2 mm.
34. A method according to any of clauses 31 to 33, wherein the at least one cementitious binder is selected from GGBS, cement or fly ash, Portland cement or a mixture thereof, preferably GGBS or cement, preferably cement.
35. A method according to any of clauses 31 to 34, wherein the plastic aggregate pellet comprises at least one inorganic base.
36. A method according to clause 35, wherein the at least one inorganic base comprises an alkali hydroxide, alkali oxide or alkali carbonate or a mixture thereof, preferably sodium hydroxide, sodium carbonate or a mixture thereof.
37. A method according to any one of clauses 31 to 36, wherein the plastic is a synthetic or semi-synthetic plastic, or a rubber, preferably synthetic or semi-synthetic plastic, more preferably a synthetic plastic.
38. A method according to any one of clauses 31 to 37, wherein the plastic is plastic-based foam, preferably the plastic-based foam comprises polyurethane (PUR) or polyisocyanurate (PIR), preferably PUR.
39. A method according to any one of clauses 31 to 38, wherein the plastic is derived from waste plastic, such as waste plastic-based foam.
40. A method according to any of clauses 31 to 39, wherein the weight ratio of water to cementitious binder is from 0.2 to 0.6, preferably 0.3 to 0.5.
41. A method according to any of clauses 35 to 40, wherein the weight % of inorganic base is from 0% to 15% w/w of the cementitious binder, 0.1 to 15% w/w of the cementitious binder, preferably 2 to 10% w/w of the cementitious binder.
42. A method according to any of clauses 31 to 41, wherein the plastic aggregate pellet further comprises at least one additive, preferably the at least one additive is an admixture, a strength enhancer, a rheology modifier, a pigment, or a fiber, preferably a pigment.
43. A method according to clause 42, wherein the at least one additive is a mineral.
44. A method according to any of clauses 31 to 43, wherein the plastic aggregate pellet comprises from 0.01 to 5 wt % of the at least one additive.
45. A method according to any one of clauses 31 to 44, wherein the plastic aggregate pellet further comprises at least one filler, preferably the at least one filler is limestone, sand, wood, clay, concrete dust, microsilica, or char, preferably limestone and/or calcined clay and/or microsilica.
46. A method according to clause 45, wherein the plastic aggregate pellet comprises from 0.01 to 40 wt % of the at least one filler.
47. A method according to any one of clauses 31 to 46 wherein the plastic aggregate pellet comprises calcined clay, limestone, high strength cement.
48. A concrete composition comprising a carbonated plastic aggregate obtained by any one of clauses 1 to 47.
49. A concrete block comprising a carbonated plastic aggregate obtained by any one of clauses 1 to 47.

### EXAMPLES

### Materials

The following materials were used as supplied:
Cement supplied by Hanson
Granulated ground blast furnace slag (GGBS) supplied by Hanson.
Granulated ground blast furnace slag (GGBS) supplied by Lkab.
Large aggregate (10 mm Limestone) supplied by MKM Building Supplies
Small aggregate (sharp sand—0-4 mm) supplied MKM Building Supplies Water
PUR Plastic Aggregate (derived from PUR rigid foam)
NaOH supplied by Inovyn
Na₂CO₃ supplied by DirectChem.
Graphene suspension supplied by Graphene Star
Limestone powder supplied by Longcliffe
Calcined Clay supplied by Materials Marketing.
High Strength Cement (HSC) supplied by Hanson

### Example 1—Manufacturing of a Plastic Aggregate

### Mix Designs:

Preferred mix
PUR: GGBS 1:1.2
Water/GGBS 0.4
Sodium hydroxide 5% w/w of GGBS
Sodium carbonate 5% w/w of GGBS

### Method:

After receiving PUR rigid foam as pellets/powder from recycler or manufacturer, the plastic was treated (granulated, sieved and reformulated in the desired size distribution (greater than 0.2 mm and less than 4 mm)).

The desired amount of plastic powder (20.8 kg) and GGBS (25 kg) were added in a paddle mixer and stirred together for a few minutes to obtain a good dispersion of the two materials. The activators (sodium hydroxide, 150 g, and sodium carbonate, 150 g) were added to the required water (10 kg). The solution was stirred vigorously until complete dissolution of the chemicals. At room temperature (20-25° C.) this sodium carbonate solution would not be stable, because the concentration is above the solubilisation limit. However, the solubilisation of NaOH generates enough heat to increase the solubility of sodium carbonate and to obtain complete dissolution of the chemicals.

As soon as the solution was ready (before it cooled down and caused the precipitation of sodium carbonate), it was added to PUR and GGBS in the mixer, while continuously stirring. Once all the solution was added, the mix was stirred further for a few minutes, until a homogeneous wet powder-like mix was obtained (aggregate mix).

The pelletiser process begins with heating up the machine, by running through it a “primer mix” (sand, flour, wood shavings and vegetable oil). In this way, when the aggregate mix will be processed, the temperature of the process die will be already high enough to have the desired accelerating curing effect on the pellets. Typically, the temperature range is 50-100° C. The pelletising die is typically a disc or ring with a series of countersunk holes with a set compression ratio, the die hole diameter was 6 mm. A knife was used to cut the formed plastic aggregate to the desired length and to create a size distribution. The compression value of the die is the ratio of the die hole diameter and die thickness, the die thickness is 27 mm, giving a compression value of 4.5. Compression values can range from 4 to 8 depending on the aggregate produced and desired application.

The aggregate mix was processed through the pelletiser, (sieved while still uncured and moist to remove the fines (<2 mm)), and the fines were collected to be recycled back into the system. The pellets >2 mm came out of the sieve and onto a conveyor belt and loaded into a bulk bag which stays warm for multiple days and set aside for a minimum of 4 days to cure.

Once the plastic aggregate had cured enough, it was then sieved again using a 2 mm screen to remove any of the fines, this material was then collected in a bulk bag and was ready to be used in concrete applications, however the curing process of the GGBS in the aggregate will continue for weeks and undergo carbonation, which will further increase the strength of the aggregate. Any unreacted GGBS left in the aggregate before use is expected to react with the cementitious binder such as Portland cement that is present in the concrete due to the high alkalinity of Portland cement.

### Compressive Strength Testing

The compressive strength of precast concrete made with plastic aggregate pellets (25% of the volume of the large aggregate) has been compared with the compressive strength of precast concrete in which the same volume of the large aggregate (25%) is substituted by:
the plastic aggregate mix left to cure without pelletisation, to show that forming into an aggregate without the heat and pressure of the present invention results in a concrete with worse properties than concrete of the present invention,
A PUR-only pellet aggregate, without GGBS and the chemicals, to show that the cementitious binder improves the strength of the concrete of the present invention,
PUR powder, to demonstrate that putting PUR into concrete without forming it into a larger particle results in a concrete with worse properties than concrete of the present invention.

The mix designs used for the preparation of the precast concrete are summarised in Table 1.

TABLE 1
Mix designs of precast concrete.

| | OPC/ | Large | Sand/ | Synthetic | Water/ |
|---|---|---|---|---|---|
| | kg | Aggregate/kg | kg | Aggregate kg | kg |
| Plastic | 3.500 | 5.623 | 6.647 | 0.730 | 1.575 |
| aggregate | | | | | |
| pellets | | | | | |
| Plastic | 3.500 | 5.623 | 6.647 | 0.665 | 1.575 |
| aggregate mix | | | | | |
| PUR-only | 3.500 | 5.623 | 6.647 | 0.495 | 1.575 |
| pellets | | | | | |
| PUR powder | 3.500 | 5.623 | 6.647 | 0.460 | 1.575 |

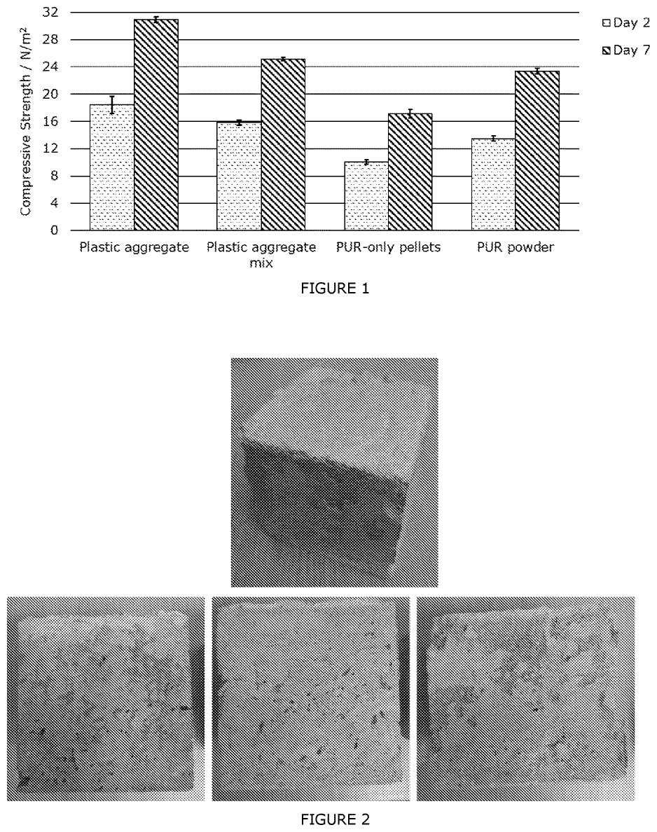

The concrete was cast into 10×10 cm moulds and crushed after 2 and 7 days of curing (3 moulds each time). The results are summarised in FIG. 1.

FIG. 1 shows that the concrete comprising plastic aggregate had higher compressive strength compared to the concrete comprising (i) the plastic aggregate mix (i.e. left to cure without pelletisation), or (ii) PUR-only pellets, or (iii) PUR powder. The concrete comprising plastic aggregate had higher compressive strength after both 2 days and 7 days of curing.

To better show the segregation of PUR in concrete and the better dispersion of the plastic aggregate, two more mixes were made, in which only either PUR plastic or plastic aggregate pellets were used as aggregate.

The mix is prepared by placing 2 kg of cement in a 5 L bucket and filling it to the top with either plastic aggregate pellets or powdered PUR, to achieve the same volume of ingredients. The amount of water required to make similar consistencies was added to the mixture. More water is required by the powdered PUR. The mix designs used are summarised in Table 2.

TABLE 2
Mix designs of precast concrete with plastic aggregate
pellets or PUR powder.

| | OPC/ | Plastic Aggregate | PUR | |
|---|---|---|---|---|
| Mix # | kg | pellets/kg | powder/kg | Water/kg |
| 1 | 2.000 | 2.700 | — | 1.300 |
| 2 | 2.000 | — | 1.700 | 1.700 |
| 3 | 2.000 | — | 1.700 | 2.500 |

The compressive strength and density of the concrete are summarised in Table 3.

TABLE 3
Compressive strength and density of the concrete.

| | Compressional | Compressional | |
|---|---|---|---|
| Mix | strength 3 | strength 7 | Density/kg |
| # | day/mpa | day/mpa | m³ |
| 1 | 9.1 | 11.4 | 1281 |
| 2 | 2.2 | 3.3 | 865 |
| 3 | 1.0 | 1.9 | 766 |

FIG. 2 shows concrete cubes, showing mix 1 (left), 2 (centre bottom) and mix 3 (right). The top picture is a concrete cube corresponding to mix 2.

Mix 1, 2 and 3 in FIG. 2 correspond to mix 1, 2 and 3 as shown in Tables 2 and 3.

It can be seen in FIG. 2 that the concrete cubes corresponding to mix 2 and 3 contain lots more cracks on the surface compared to the concrete cube corresponding to mix 1. Additionally, the top of the concrete for mix 2&3 have a layer of separated plastic on the top due to separation (top picture in FIG. 2).

These results show that incorporation of plastic aggregate pellets leads to improved dispersion of the plastic into the concrete and stronger concrete.

The effect of activators, sodium hydroxide and sodium carbonate, was tested by measuring the compressive strength of GGBS-based concrete over time, with sodium hydroxide or carbonate alone (10% in weight of GGBS) and with both together (5% in weight of GGBS of each). The mix designs for the three samples are summarised in Table 4.

TABLE 4
Mix designs of GGBS based concrete.

| | | Large | | | | |
|---|---|---|---|---|---|---|
| | GGBS/ | Aggregate/ | Sand/ | NaOH/ | Na₂CO₃/ | Water/ |
| | kg | kg | kg | kg | kg | kg |
| Sample | 5.000 | 12.500 | 4.900 | 0.500 | — | 2.500 |
| 1 | | | | | | |
| Sample | 5.000 | 12.500 | 4.900 | — | 0.500 | 2.500 |
| 2 | | | | | | |
| Sample | 5.000 | 12.500 | 4.900 | 0.250 | 0.250 | 2.500 |
| 3 | | | | | | |

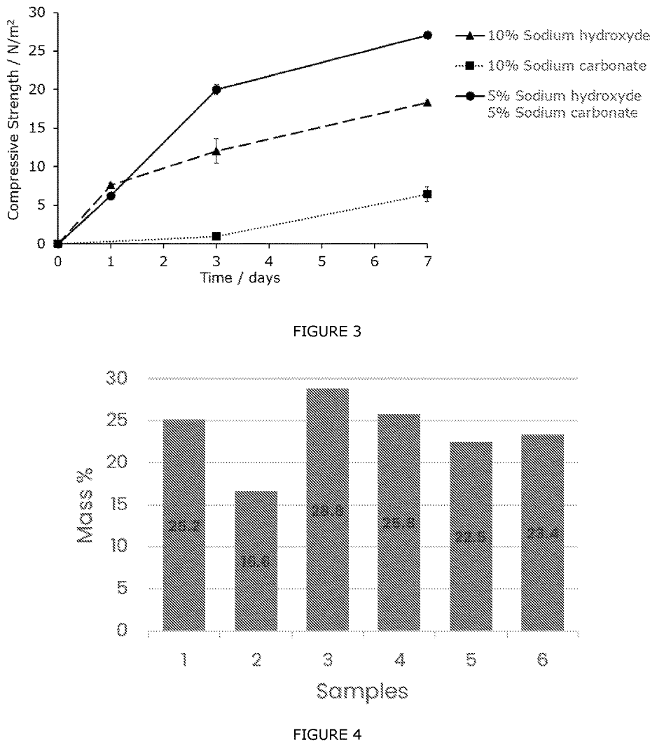

The concrete was cast into 10×10 cm moulds and crushed after 1, 3 and 7 days of curing (3 moulds each time). The results are summarised in FIG. 3.

FIG. 3 shows the effect of sodium hydroxide and sodium carbonate (“activators”) on the curing of GGBS. Sodium hydroxide alone can speed up the early strength gain, with a comparable strength after one day that using both the chemicals. After that though, the strength remains lower. The addition of sodium carbonate does not affect the early strength (after 1 day) but improves significantly the final strength. Technical advantages are thus obtained when there is one chemical present, or a combination of two or more (such as the sodium hydroxide and sodium carbonate demonstrated). In conclusion, the activator solution for GGBS results in a quicker early strength gain and a higher final strength.

### Conclusions

The compressive strength of concrete made with the same volume of plastic aggregate pellets, plastic aggregate mix, PUR-only pellets, and PUR powder, substituting 25% volume of large aggregate, clearly shows higher values for the plastic aggregate pellets of this invention. This represents evidence that the method (particularly the heat and pressure (e.g. pelletiser), the presence of a cementitious binder and of the inorganic base activator) improves the property of the final concrete obtained when waste plastic is incorporated. The method essentially is an effective way to improve the dispersion and compatibility of the waste plastic into the concrete matrix.

### Example 2—Manufacturing of Graphene-Containing Plastic Aggregate

### Method

The PUR rigid foam was treated as explained in Examples 1-3 (granulated, sieved and reformulated in the desired size distribution (between 0.2 mm and 4 mm)).

The desired amount of plastic powder and GGBS were added in a paddle mixer and stirred together for a few minutes to obtain a good dispersion of the two materials. While continuously stirring, graphene was added by weighing a variable amount of the dispersion suspension, and then the added water was adjusted, to take into account the water added already with the graphene suspension, so that the total water added is always the same for all the pellets. Sample 1 was prepared as a control sample without adding graphene. The quantities of materials used are summarised in Table 5.

TABLE 5
Mix designs for graphene-containing plastic aggregate

| | | | Graphene | | | |
|---|---|---|---|---|---|---|
| Sample | GGBS/ | PUR/ | suspension/ | NaOH/ | Na₂CO₃/ | Water/ |
| # | kg | kg | g | kg | kg | kg |
| 1 | 2.4 | 2 | 0 | 0.12 | 0.12 | 1.056 |
| 2 | 2.4 | 2 | 50 | 0.12 | 0.12 | 1.006 |
| 3 | 2.4 | 2 | 100 | 0.12 | 0.12 | 0.956 |
| 4 | 2.4 | 2 | 150 | 0.12 | 0.12 | 0.906 |
| 5 | 2.4 | 2 | 200 | 0.12 | 0.12 | 0.856 |
| 6 | 2.4 | 2 | 400 | 0.12 | 0.12 | 0.656 |

Once all the required water was added, the mix was stirred further for a few minutes, until a homogeneous wet powder-like mix was obtained (aggregate mix).

Each aggregate mix was processed through the pelletiser and collected into a plastic tub and set aside for a minimum of 4 days to cure. Once the graphene-enhanced plastic aggregate had cured enough, it was ready to be analysed and used in concrete testing.

### Resistance to Tumbling

A rock tumbler has been used to test the strength and resistance of aggregate, as an in-house adaptation of the Los Angeles test (BS EN 1097-2).

The aggregate has been tumbled for 20 hours and the % mass variation of the fines (<2 mm) has been measured. The results are shown in FIG. 4.

The lower the number of fines after tumbling, the stronger the pellets tested.

FIG. 4 shows that samples 2, 5 and 6 are stronger than the control without graphene (Sample 1). Samples 3 and 4 are slightly less strong than the control. Despite this, all plastic aggregates comprising graphene resulted in stronger concrete compared to appropriate comparisons without graphene, as described below.

### Precast Concrete Compressive Strength

Precast concrete was made with graphene-plastic aggregate pellets replacing 25% and 50% of the volume of the large aggregate. The concrete samples are labelled as CX_Y, where X corresponds to the plastic pellets sample number as given above (in Table 5, i.e., samples 1 to 6) and Y is the vol % of large aggregate replaced. The mix designs are shown in Table 6.

TABLE 6
design mix for concrete comprising graphene-plastic aggregate pellets

| | Cement/ | Sand/ | Large | Pellets/ | Water/ |
|---|---|---|---|---|---|
| Concrete # | kg | kg | Aggregate/kg | kg | kg |
| C1_25 | 4.75 | 9.00 | 7.60 | 1.05 | 2.14 |
| C2_25 | 4.75 | 9.00 | 7.60 | 1.05 | 2.14 |
| C3_25 | 4.75 | 9.00 | 7.60 | 1.05 | 2.14 |
| C4_25 | 4.75 | 9.00 | 7.60 | 1.05 | 2.14 |
| C5_25 | 4.75 | 9.00 | 7.60 | 1.05 | 2.14 |
| C6_25 | 4.75 | 9.00 | 7.60 | 1.05 | 2.14 |
| C1_50 | 4.75 | 9.00 | 5.09 | 2.07 | 2.14 |
| C2_50 | 4.75 | 9.00 | 5.09 | 2.07 | 2.14 |

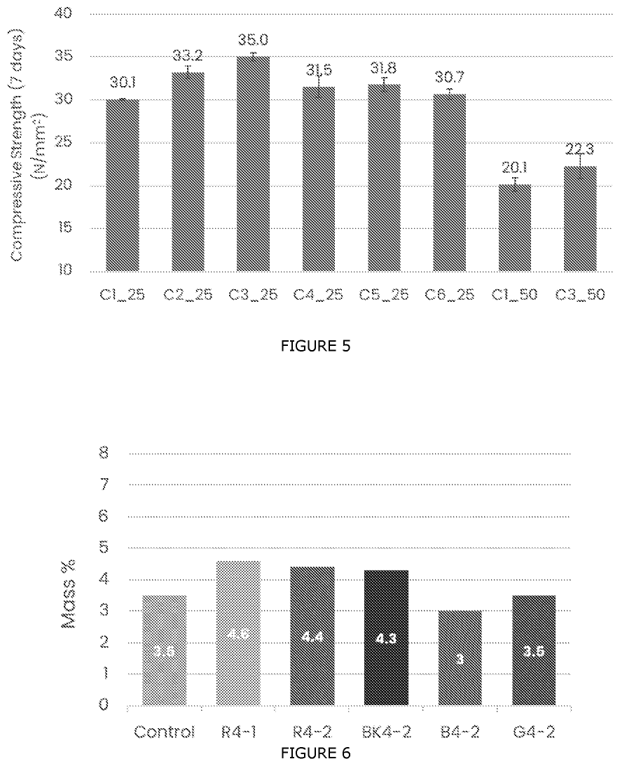

The compressive strength recorded after 7 days of curing are shown in the FIG. 5.

FIG. 5 shows that all compositions C2-25 to C6-25 (i.e., graphene containing) have a greater strength than C1-25 (no graphene). FIG. 5 also shows that the highest replacement of large aggregate (50%—C1-50 and C3_50) gives a lower strength as expected. However, the samples that gave the best results in the tumbler test (Samples 2, 5 and 6) also give stronger concrete, in comparison with the one made with the control pellets (Sample 1). This shows that the addition of the graphene improves the strength by 10-17%

### Conclusion

Addition of graphene as an additive in the plastic aggregate leads to improved strength of the plastic aggregate and improved strength of concrete comprising the graphene-containing plastic aggregate (by 10 to 17%).

### Example 3—Manufacturing of a Plastic Aggregate Using a Binder and No Alkaline Activator Solution

### Method

The PUR rigid foam was treated as explained in the previous examples (granulated, sieved and reformulated in the desired size distribution (between 0.2 mm and 4 mm)).

The desired amount of plastic powder and the binders (GGBS, Limestone, Calcined Clay and HSC) were added in a paddle mixer and stirred together for a few minutes to obtain a good dispersion of the two materials. While continuously stirring, the required water was added, the mix was stirred further for a few minutes, until a homogeneous wet powder-like mix was obtained (aggregate mix). One sample was prepared, with a binder:PUR ratio of 1:5. The quantities of materials used are summarised in Table 7.

TABLE 7
design mix for a plastic aggregate using
no alkaline activator solution

| Sample | PUR/ | GGBS/ | Limestone/ | Calcined | HSC/ | Water/ |
|---|---|---|---|---|---|---|
| # | kg | kg | kg | Clay/kg | kg | kg |
| 7 | 1.00 | 2.60 | 1.45 | 0.7 | 0.25 | 1.50 |

The aggregate mix was processed through the pelletiser as discussed above, sieved while still uncured and moist to remove the fines (<2 mm). The pellets >2 mm collected out of the sieve were collected into a plastic tub and set aside for a minimum of 4 days to cure. Once the plastic aggregate had cured enough, it was ready to be analysed.

### Resistance to Tumbling

After 20 hours of tumbling, the % mass variation of the fines (<2 mm) has been measured as 40.6%. If the aggregate did not undergo some amount of curing during the 4 days, then 90%+ fines would be expected as it would completely break up.

Due to using the HSC it would be expected that the strength of the aggregate to continue to increase further over time.

This result shows that it is possible for the binder mixture to cure with the use of a substance like HSC instead of a water soluble alkaline activator.

### Example 4—Manufacturing of Pigmented Aggregate

### Method

Pigmented pellets were prepared by preparing the aggregate as describe above, but adding the pigment to the powders in the paddle mixer and stirring together for a few minutes to obtain a good dispersion of the materials. For each colour, part of the PUR was replaced with pigment in 2 levels, 1% and 3.7% of the total mass. The pellets are labelled as XY-1 or XY-2, where X is related to the pigment colour used (R: red, G: green, B: blue, Y: yellow, BK: black), and Y is the die hole diameter (4, 6 or 8 mm), and −1 or −2 refer to the level of pigment in the mix (1 for the lower percentage, 1%; 2 for the higher percentage, 3.7%).

The quantities of materials used are summarised in the Table 8.

TABLE 8
design mix for manufacturing pigmented plastic aggregates

| Sample | GGBS/ | PUR/ | Pigment/ | NaOH/ | Na₂CO₃/ | Water/ |
|---|---|---|---|---|---|---|
| # | kg | kg | g | kg | kg | kg |
| Control | 1.2 | 1 | 0 | 0.06 | 0.06 | 0.4 |
| XY-1 | 1.2 | 0.97 | 2.72 | 0.06 | 0.06 | 0.4 |
| XY-2 | 1.2 | 0.90 | 10 | 0.06 | 0.06 | 0.4 |

Once all the required water was added, the mix was stirred further for a few minutes, until a homogeneous wet powder-like mix was obtained (aggregate mix).

Each aggregate mix was processed through the pelletiser, using a 4 mm, 6 mm and 8 mm die then collected into a plastic tub and set aside for 7 days to cure.

After 7 days of curing, each sample was tested in the tumbler resistance, to verify that the presence of pigments does not affect the pellets' stability. The results are discussed below.

In another test, cubes of concrete made with pigmented pellets were also exposed to sunlight for a few days, to test the UV stability of the pigments. The results are discussed below.

### Resistance to Tumbling

After 20 hours of tumbling, the % mass variation of the fines (<2 mm) has been measured. The results are shown in FIGS. 6 to 8.

FIG. 6 shows the results obtained with 4 mm pellets.

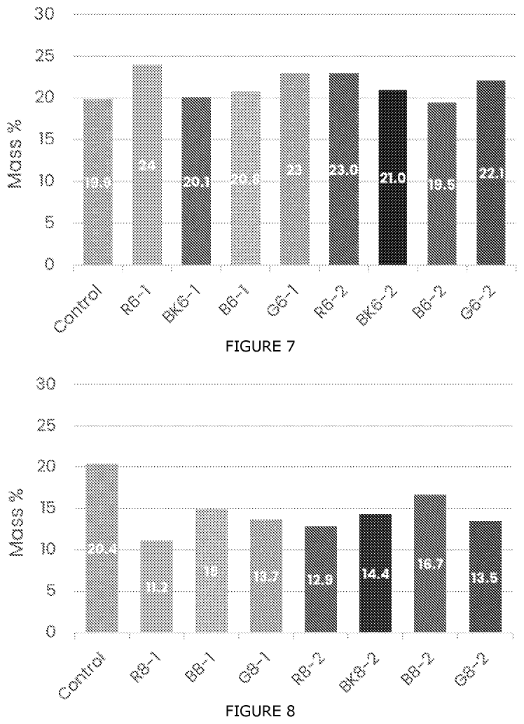

FIG. 7 shows the results obtained with 6 mm pellets.

FIG. 8 shows the results obtained with 8 mm pellets.

Overall, FIGS. 6 to 8 show that the 4 mm pellets are stronger (less amount of fines after tumbler) than the other 2 dimensions, because the smaller diameter of the die allows a higher pressure of the material through the pelletiser. Not much difference is seen between 6 and 8 mm. For the 4 and 6 mm pellets, the pigments, in the 2 different percentages, do not seem to affect the strength of the pellets, with the number of fines after tumbling comparable to the control without pigment for most of them. Red pigment, in both 4 and 6 mm pellets, black pigment for 4 mm pellets and green pigments for 6 mm pellets, gave between 10 and 30% more fines after tumbling than the control. However, this effect does not increase with the increasing amount of the same pigment in the mix, showing that it is likely not related to the pigment itself but to the error of the testing method.

For the 8 mm pellets, the addition of pigments gave stronger pellets with each colour and in both percentages of pigment in the mix.

### Sunlight Exposure

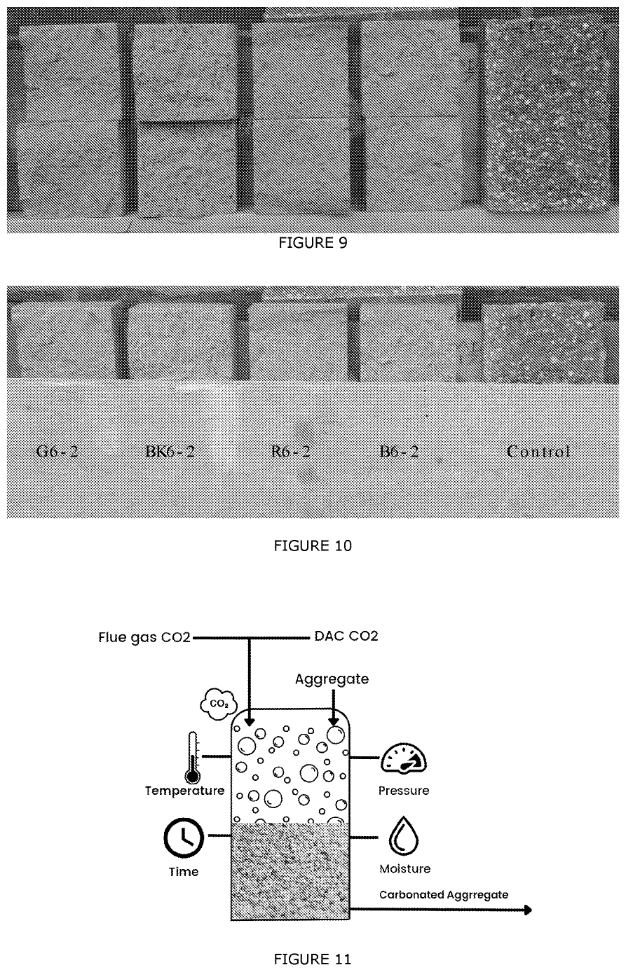

Some of the pigmented pellets and the control pellets were used as aggregate to make concrete, and the cubes were partially exposed to sunlight and partially not, to verify the stability of the plastic and of the colours under sunlight. The setup is shown in FIGS. 9 and 10.

FIG. 9 shows four stacks of two cubes each, and a control cube.

FIG. 10 shows that the top cubes and the top half of the control cube are partially exposed to sunlight; and that the bottom cubes and the bottom half of the control cube is covered.

The cubes were exposed for 2 months. The comparisons between the exposed and unexposed cubes revealed that the colour of the pigment is not affected by the sunlight. The concrete surfaces exposed to sunlight but which contained the pigmented plastic aggregate were not observed to be yellow.

However, the control concrete (without pigment) turned yellower under sunlight.

### Conclusions

Concrete blocks comprising plastic tend to turn yellow over time when exposed to sunlight, which is undesired. Pigmenting the plastic aggregate represents an advantage, as the yellowing of concrete comprising the pigmented aggregate is diminished or no longer visible, while the colour of the pigment is not affected by sunlight.

### Example 5—Manufacturing of a Carbonated Plastic Aggregate

### Carbonation Theoretical Calculations:

CaOₘ—Mass of calcium oxide in kg
CaO %—Percentage of calcium oxide present in the sample
Aₘ—mass of the plastic aggregate in kg
Moles_{CaO}—Number of moles of calcium oxide in the sample
MᵣCao—Molar mass of calcium oxide
CO₂^{m}—The maximum mass of carbon dioxide can react with the sample
Moles_{CO2}—Number of moles of carbon dioxide in the sample
MgOₘ—Mass of magnesium oxide in kg
MgO %—Percentage of magnesium oxide present in the sample
Moles_{MgO}—Number of moles of magnesium oxide in the sample
MᵣMg_{O}—Molar mass of Magnesium oxide
Total_{CO2}—The sum of the maximum mass of carbon dioxide that can react with the calcium oxide and magnesium oxide components

$${CaO}_{m} = CaO \% \times {A}_{m} = 32.55 \% \times 1 kg = 0.3255 kg CaO$$

Moles of CaO:

$${Moles}_{CaO} = \frac{{CaO}_{m}}{{M}_{r} CaO} = \frac{0.3 \; 255 kg}{56.0 \; 774 g / mol} = 5.8 moles of CaO$$

Stoichiometric ratio of 1:1

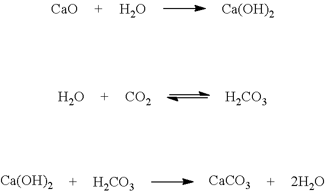

Overall equation

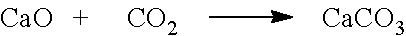

$${Moles}_{CaO} = {Moles}_{CO 2}$$

$${CO}_{2}^{m} = M o l e {s}_{CO 2} \times {M}_{r} {CO}_{2} = 5.8 mol \times 44.01 g / mol = 0.256 kg {CO}_{2}$$

$${Mg}_{m} = MgO \% \times {A}_{m} = 5.2 \% \times 1 kg = 0.052 kg M gO$$

$${Moles}_{MgO} = \frac{{MgO}_{m}}{{M}_{r} MgO} = \frac{0.0 \; 52 kg}{40.3 \; 044 g / mol} = 1.29 moles of MgO$$

Stoichiometric ratio of 1:1

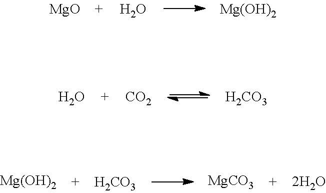

Overall equation:

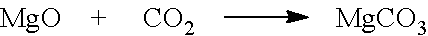

$${Moles}_{MgO} = {Moles}_{CO 2}$$

$${CO}_{2}^{m} = {Moles}_{MgO} \times {M}_{r} {CO}_{2} = 1.29 mol \times 44.01 g / mol = 0.0 \; 57 {kg CO}_{2}$$

$${Total}_{CO 2} = \sum {CO}_{2} = 0.3255 kg + 0.057 kg = 0.3825 kg CO 2$$

### Results

An aggregate made from GGBS and sand was prepared using pelletisation in a similar manner as described in Examples 1 and 2. After 24 hours of curing, the samples were separated into Sample 5-01, Sample 5-02 and Sample 5-03.

Sample 5-01 was the control and was vacuum-packed to reduce the exposure to the atmosphere as much as possible. Sample 5-02 was the aggregate from the pelletiser without modification such as sieving and contained larger particles. Sample 5-03 was granulated to reduce the particle size to increase the rate of carbonation and left spread out on a plastic tray and kept near Sample 5-02.

The aggregates were left undisturbed for 4 weeks in their various containers and then sent off for external analysis.

### Example Calculation

1 kg of the aggregate has 4.38% CO₂. This gives a ratio of 95.62:4.38 (sample: CO₂)

The maximum amount of CO₂ 1 kg of the mix can absorb is 0.3825 kg CO₂, giving a ratio of 1:0.3825 (sample: CO₂).

This gives a maximum percentage of CO₂ to be

$$\frac{0.3826}{1 + 0.3825} \times 100 = 27 \text{.67} \%$$

CO₂ content
% of total maximum can then be calculated

$$\frac{4.38}{27.67} = 15 \text{.8} \%$$

The same calculations were used for samples Sample 5-02 and Sample 5-03.

TABLE 9
The % CO₂ measured by external testing and the % of this
compared to the maximum theoretical result

| Sample | % CO₂ | % of total maximum |
|---|---|---|
| Sample 5-01 | 4.38 | 15.8 |
| Sample 5-02 | 7.13 | 25.5 |
| Sample 5-03 | 7.35 | 26.7 |

As Sample 5-01 has a lower % CO₂ content than the other samples, it shows that when an aggregate is made with GGBS that it will passively carbonate to a significant degree after 4 weeks of exposure to air.

Sample 5-01 had a surprising amount of % CO₂, this could be from a couple of different things, such as the carbonation reaction taking place at a much faster rate and that significant carbonation can occur in the first 24 hours of the sample being prepared. Alternatively, it could also be due to the external testing where it is unknown if the sample were exposed to the atmosphere for a week or so before being tested.

### Conclusion

This experiment shows that the aggregate according to the present invention has the appropriate properties so that it is able to undergo carbonation and achieve up to 27% carbonation in 4 weeks using just passive carbonation. This demonstrates the potential of the plastic aggregate to carbonate. The rate of carbonation of the aggregate is expected to be increased up to 100% carbonation by using active carbonation steps in addition or instead of passive carbonation. Furthermore, active carbonation will greatly increase the rate of carbonation, making it quicker to store the CO₂ and subsequently for the aggregate to then be usable in products/applications.

### Example 6—Active Carbonation of a GGBS-Based Aggregate

A die pelletiser was used to create a GGBS-based aggregate (sample 8).

The sample was prepared by mixing the dry components followed by the addition of the inorganic base solution and water. The resulting mixture can be described as being able to “snowball”, whereby the mixture is able to stick together when squeezed by hand.

The die pelletiser was preheated using a “cleaning mixture” which consists of non-hardening materials such as a mixture of sawdust, sand and water. The die consisted of 6 mm diameter holes. The samples were bagged immediately after production and left covered to cure.

TABLE 10
The breakdown of the materials used to create sample 8.

| Material | Sample 8/wt % |
|---|---|
| PUR | 37.3 |
| GGBS | 44.8 |
| Inorganic base solution | 6.7 |
| Water | 11 |
| Total | 99.8% |
| CaO % | 17.9% |

After 1 day of curing (hardening), 25 wt % of water (with respect to the sample weight) was added to the sample, after which they were placed in a metal bowl in the reaction vessel for exposure to carbon dioxide.

During the test, air was completely removed from the vessel using a vacuum pump, after which 99.9% carbon dioxide was slowly injected into the vessel until a pressure of 2 bar was reached. Once the pressure was reached, the connection to the carbon dioxide was closed off. The samples were then left exposed for 76 hours at room temperature to react.

After 76 hours, the samples are removed from the chamber and dried for 24 hours at 100° C.

The samples were then analysed by placing the samples in dilute HCl, which liberates CO₂ from the CaCO₃ and MgCO₃ in a sealed vessel. The resulting increase in pressure from the CO₂ is directly proportional to the amount of carbonates in the samples and was compared to a calibration curve to obtain the total carbonate % in the sample.

TABLE 11
The total carbonate % and the % of maximum carbonation for sample 8

| Material | Total carbonate % | % of maximum carbonation |
|---|---|---|
| Sample 8 (GGBS) | 15.91 | 44.2% |

The GGBS used in sample 8 had a typical CaO content of 40% and a MgO content of 10%. Based on the mix design, the maximum amount of carbonation that can occur is 0.19 kg CO₂/kg sample 8.

$$Max CO 2 = w \times C \times ( \frac{m CO 2}{M CaO} )$$

$$Max CO 2 = 0.4 kg CaO / kg \times 0.448 \times ( \frac{44}{56} )$$

$$Max CO 2 = 0.1451 kg CO 2 / kg Sample 8$$

$$Max CO 2 = w \times C \times ( \frac{m CO 2}{M MgO} )$$

$$Max CO 2 = 0.1 kgCaO / kg \times 0.448 \times ( \frac{44}{40.3} )$$

$$Max CO 2 = 0.0489 kg CO 2 / kg Sample 8$$

At 100% carbonation, the aggregate will have increased by 19% in weight, giving a maximum CO₂ absorption of 16% or a carbonate % of 36%.

This experiment shows that the GGBS-based aggregate is able to undergo active carbonation. Significant carbonation was obtained with Sample 8, at 44.2% of the maximum carbonation possible. The active carbonation therefore leads to increased carbonation, and at an increased rate, compared to passive carbonation (see Example 5, where Samples 5-02 and 5-03 only achieved up to 27% of maximum carbonation after a significantly extended period of time, i.e. 4 weeks).

### Example 7A: Active Carbonation Using Added Water (Bulk Aggregate Carbonation)

Four different samples were prepared using the same mix as sample 8 (Example 6), but investigated with different parameters, such as time and additional water content. The samples were prepared using the same method outlined in Example 6. After 24 hours of hardening, 60 kg of the sample were taken into a bulk bag.

For sample 9, 10% of additional water (6 kg) was sprayed evenly over the material. Due to the absorbent nature of the mixture, the moisture was able to penetrate throughout the 60 kg sample.

For samples 10 and 11, the 60 kg was fully emersed in water, and allowed to drain, leaving a moisture content of 42%.

After the designated timeframe, the top 30 kg of material in the bull bag was removed from the surface and 4 kg of material was taken from the deepest section of the bag. This is to ensure that carbonation occurs deep within an aggregate pile.

The 4 kg of material was placed in an oven for 24 hours at 100° C. to stop the carbonation process (as moisture is required to dissolve atmospheric carbon dioxide to allow the carbonation reaction to occur).

It should be noted that sample 8 had no additional water added, but retains a natural moisture content of 10% that remains from the initial mix.

TABLE 12
Carbonation results for samples made with the mix stated for sample 8

| | Sample 8 | Sample 9 | Sample 10 | Sample 11 |
|---|---|---|---|---|
| Additional | 0 | 10% | 32% | 32% |
| water content | | | | |
| wt % | | | | |
| Days of | 7 | 7 | 3 | 7 |
| exposure | | | | |
| % of maximum | 14.2 | 17.2 | 18.6 | 24.4 |
| carbonation | | | | |

Once dried, the samples were sent for carbonate % testing according to the BS EN 196: Part 2:2013 standard. The carbonate % was then converted to the % of the maximum possible carbonation that can occur.

The results show that a significant amount of carbonation of the mixture can occur during the week-long storage of the aggregate. This can be increased by the addition of extra moisture. This is believed to allow for more carbon dioxide to be dissolved in the aggregate to then subsequently react with the calcium and magnesium content on the GGBS.

### Example 7B: Surface Layer Active Carbonation Using Added Water

In another example, the aggregate was spread out over a large area, increasing the available surface area for the carbon dioxide to dissolve. 4 kg of aggregate made with the same mix as sample 8 (see Example 6) were spread evenly across a plastic tray. Sample 12 had an initial 1.5 kg of water sprayed over the surface and was sprayed with 200 ml every 2 days to keep the surface wet.

Both samples were left for 14 days, after which both samples were dried at 100° C. for 24 hours. After that, the samples were tested for carbonate % to the BS EN 196: Part 2:2013 standard.

TABLE 13
The % of maximum carbonation results for spray-out aggregate.

| Sample | % of maximum carbonation |
|---|---|
| Sample 8 | 25.0 |
| Sample 12 | 42.0 |

The results show that the addition of water to the sample increases the amount of carbonation that has occurred (consistent with the bulk aggregate carbonation results). Overall, the % maximum carbonation results are higher. This is believed to be mainly due to the samples being spread out over a larger area, increasing the exposed surface area of the aggregate (rather than the increased exposure time to CO₂).

### Example 8: Environmental Impact of Carbonated GGBS- and Cement-Based Aggregates

| | Raw | | | | |
|---|---|---|---|---|---|
| | material | Sample 8 | | Sample 13 | |
| | (A1-A3) | (GGBS-based aggregate) | | (cement-based aggregate) | |
| | kg | | kg | | kg |
| Material | CO₂e/T | % material | CO₂e/kg | % material | CO₂e/kg |
| PUR | 0 | 37.3 | 0 | 38 | 0 |
| GGBS | 75 | 44.8 | 0.034 | 0 | 0 |
| CEM II | 761 | 0 | 0 | 45.8 | 0.35 |
| Inorganic | 70 | 6.7 | 0.00469 | 0 | 0 |
| base | | | | | |
| solution | | | | | |
| Water | 0 | 11 | 0 | 16 | 0 |
| Total | — | 99.8% | 0.0387 | — | 0.35 |

Note:
The skilled person would know that when calculating the carbon footprint of materials, A1 refers to the raw materials, A2 refers to transportation of the materials to the suppliers site, and A3 refers to emissions due to manufacturing.

The carbonation potential of both of these aggregates used in this example (GGBS and CEM II-aggregates) is 0.19 kg CO₂/kg at 100% carbonation, therefore the 0.084 kg CO₂/kg for sample 8 is based on 0.442*0.19=0.084. Sample 8 (GGBS-based) had a carbonation of 44.2%, meaning that a kg of the product would have absorbed 0.084 kg CO₂. Once this sequestered carbon has been removed from the total emissions of the raw materials (0.0387 kg CO₂e/kg), the carbon footprint of a GGBS based aggregate is −0.0453 kg CO₂e/kg.

This shows that the use of GGBS as a binder for the aggregate allows for the production of a carbon-negative aggregate when active carbonation has been conducted.

An aggregate produced using CEM II (Sample 13) that has undergone the same carbonation would have a carbonation % of 51.4%, meaning that a kg of the aggregate would have absorbed 0.098 kg CO₂. Once this sequestered carbon has been removed from the total emissions of the raw materials (0.35 kg CO₂e/kg), the carbon footprint of the CEM II-based aggregate would be 0.25 kg CO₂/kg.

This shows that the use of cement as a binder for the aggregate allows for the production of a low-carbon aggregate when active carbonation has been conducted versus not actively carbonating the aggregate. Notably, the aggregates described herein are strong, lightweight aggregates. Crucially, this means that although similar carbon footprints may be seen with other types of lightweight cement-binder aggregates, the carbon footprint of the aggregates of the present invention is significantly lower compared to other strong aggregates. The strength of the aggregates is assessed in Example 9 below.

### Example 9: Aggregate Strength

The typical carbon footprint of synthetic lightweight aggregates (LWAs) has a range of 0.1-0.3 kg CO₂/kg. An example of a synthetic LWA is an expanded clay. The cement-based aggregate in Example 8 has a carbon footprint of 0.25 kg CO₂e/kg after active carbonation with the potential to further absorb approximately 0.1 kg CO₂e/kg.

Although the carbon footprint is similar, the strength of the particles are noticeably different. The high strength of the aggregates of the present invention allows for uses in other applications where current LWAs cannot be used due to their lack of required strength.

To compare the strength of aggregates, a standard 10% fines test was carried out. This test looks at how much force is required to break up an aggregate to produce 10% of the material as “fines”. The higher the value, the stronger the material is.

TABLE 15
The strength comparison results for
expanded clay and sample 13

| Material | 10% fines/kN |
|---|---|
| Sample 13 (cement aggregate) | 5.37 |
| Expanded clay | 4.65 |

The results show that the cement-based aggregate is 15.5% stronger than the expanded clay. This improvement in strength can be exploited to increase the strength of concrete produced using the cement aggregate or allow for less cement to be used.

### Example 10: PUR vs Sand (Passive Carbonation)

The carbonation rate of minerals is affected by the available surface area for reaction with carbon dioxide. The original life of the PUR is from rigid foam uses. Part of this foam structure is kept when the polyurethane has been broken up. This irregular angular particle shape of the waste PUR allows an increase in porosity in the aggregate. The increased porosity allows for carbon dioxide to penetrate into the aggregate faster than using a comparative material.

To demonstrate, an aggregate (sample 14) was produced in the same way as sample 8 (Example 6) but the PUR content was replaced with sand. Sample 14 was then allowed to undergo passive carbonation.

TABLE 16
The breakdown of the materials used to create sample 14.

| Material | Sample 14/wt % |
|---|---|
| Sand | 38 |
| GGBS | 46 |
| Inorganic base solution | 7.1 |
| Water | 8.9 |
| Total | 100 |

After 7 days of atmospheric carbonation, the aggregate had a carbonate content of 6.22%, giving an overall carbonate % of 16.4%.

The GGBS used in sample 14 has a typical CaO content of 40% and a MgO content of 10%. Based on the mix design, the maximum amount of carbonation that can occur is 0.2 kg CO₂/kg sample 8.

$$Max CO 2 = w \times C \times ( \frac{m CO 2}{M CaO} )$$

$$Max CO 2 = 0.4 kg CaO / kg \times 0.46 \times ( \frac{44}{56} )$$

$$Max CO 2 = 0.145 kg CO 2 / kg Sample 8$$

$$Max CO 2 = w \times C \times ( \frac{m CO 2}{M MgO} )$$

$$Max CO 2 = 0.1 kgCaO / kg \times 0.46 \times ( \frac{44}{40.3} )$$

$$Max CO 2 = 0.05 kg CO 2 / kg Sample 14$$

At 100% carbonation, the aggregate will have increased by 20% in weight, giving a maximum CO₂ absorption of 16.7% or a carbonate % of 38%.

TABLE 17
The carbonate % and maximum carbonation
achieved for an aggregate produced with
PUR and sand after 7 days of passive carbonation.

| Material | Total carbonate % | % of maximum carbonation |
|---|---|---|
| Sample 14 (Sand) | 6.22% | 16.4% |
| Sample 8 (PUR) | 6.52% | 18.1% |

Table 17 shows that the addition of PUR in the sample improved the passive carbonation of GGBS over the same time period.

This shows the increased potential of the plastic foam PUR-based aggregate to carbonate compared to a sand-based analogue. Importantly, the carbonation % of the PUR-based aggregate will further increase when active carbonation is used instead of passive carbonation.

It should be noted that the sand used in sample 14 did have a 15% moisture content, which has not been taken into account in these calculations. If taken into account, this would result in a higher concentration of GGBS in the sample, which subsequently would increase the maximum carbonation possible, which would decrease the % of maximum carbonation that has occurred in the sand, which would further increase the difference between the sand and PUR samples.

The extra moisture in sample 14 would also increase the carbonation rate compared to sample 8, however the PUR provides faster carbonation over the same time compared to adding moisture to achieve this.

This is a useful property of the aggregate as certain applications desire as low moisture content as possible, such as those in polymer-bound concrete or asphalt concrete. These applications would require further drying of the aggregate, which is typically conducted in fossil-filled heated kilns, which would be costly and environmentally damaging.

Water absorption of the samples can be used as an indication of the porosity of the aggregates. The samples were dried for 24 hours at 100° C. to be completely dry, then 100 g of the material is left in 1 litre of water for 24 hours, the water is then drained from the sample and weighed to determine the water absorption of the material.

TABLE 18

| Water absorption for samples made of sand and PUR. | |
|---|---|
| Material | Water absorption |
| Sample 14 (Sand) | 7.2% |
| Sample 8 (PUR) | 25.0% |

Table 18 shows that the water absorption of the material made with PUR was much higher than that made with sand, indicating that the porosity of the material is higher due to the irregular shape of the PUR providing pores for water to penetrate into the material. An increase in porosity and subsequent increase in surface area allows for faster carbonation. Overall, Example 10 shows the increased potential of the PUR-based aggregate to carbonate compared to a sand-based analogue, due to the increased porosity of the plastic foam PUR. Importantly, the carbonation % of the PUR-based aggregate is expected to further increase when active carbonation is used instead of the passive carbonation used to generate the data in Table 17.

### Example 11: PUR Vs Sand (Active Carbonation)

In another example, the active carbonation of an aggregate made with sand and PUR was performed. The samples were created as the same as Example 10. After 7 days of curing, the samples were dried at 100° C. for 24 hours, after which 25% additional water was added to the samples. The samples were then placed together in a reaction vessel at room temperature and exposed to a 100% carbon dioxide atmosphere for 16 hours at a pressure of 2 bar. After which the samples were dried at 100° C. for 24 hours and the carbonate % was measured using the procedure outlined in the BS EN 196: Part 2:2013 standard.

TABLE 19
Active carbonation results of samples made of sand and PUR.

| Material | Total carbonate % | % of maximum carbonation |
|---|---|---|
| Sample 14 (Sand) | 5.76 | 15.2% |
| Sample 8 (PUR) | 15.3 | 42.5% |

The results in table 19 show that an aggregate made with sand does not react rapidly with the CO₂ during the short timeframe of 16 hours, however samples prepared using PUR shows a significant level of carbonation.

The samples made from sand also appear to have similar results to the passive carbonation of the sample, this would suggest that the CO₂ does not penetrate into the sand samples beyond what has occurred during the 7 days of passive carbonation.

This shows that the plastic (foam PUR) significantly increases the amount of carbonation that can occur during an active carbonation reaction. This is likely due to the porosity increase from the PUR whereby other fillers such as sand are able to compact, reduce the penetration of CO₂ into the sample.

The improvement of carbonation due to the PUR for a cementitious bound aggregate means that there is a greater reaction efficiency as more carbon dioxide is used during the reaction, decreased pressures being required which results in lower operating costs, energy usage, increased production rate.

1. A method of manufacturing a carbonated plastic aggregate comprising the steps of:
(i) mixing plastic particles and at least one cementitious binder comprising at least one metal oxide or metal silicate to form a first composition, wherein the plastic is derived from plastic-based foam;
(ii) providing a second composition comprising water;
(iii) mixing together the first and second compositions to form a pre-mixture;
(iv) agglomerating the pre-mixture to form a plastic aggregate; and
(v) carbonating the at least one metal oxide or metal silicate by means of an active carbonation process to obtain the carbonated plastic aggregate.

2. The method of claim 1, wherein the agglomerating comprises pressure or non-pressure agglomeration of the pre-mixture to form the plastic aggregate.

3. The method of claim 1, wherein the agglomerating comprises compressing and heating the pre-mixture.

4. The method of claim 1, wherein the agglomerating comprises briquetting or pelletisation of the pre-mixture, preferably die mill pelletisation, pan pelletisation or extrusion pelletisation of the pre-mixture.

5. The method of claim 1, wherein the agglomerating and carbonating steps are simultaneous.

6. The method of claim 1, wherein the active carbonation process comprises adding water to the cementitious binder or plastic aggregate.

7. The method of claim 1, wherein the active carbonation process comprises providing an increased airflow through the plastic aggregate.

8. The method of claim 1, wherein the active carbonation process comprises heating the plastic aggregate.

9. The method of claim 1, wherein the active carbonation process comprises exposing the plastic aggregate to a CO₂ enriched source of gas, optionally wherein the CO₂ enriched source is obtained by direct air capture or is an industrial flue gas.

10. (canceled)

11. The method of claim 1, wherein the second composition further comprises at least one inorganic base, preferably the inorganic base comprises an alkali hydroxide, alkali oxide or alkali carbonate or a mixture thereof, preferably sodium hydroxide, sodium carbonate, calcium oxide or a mixture thereof.

12. The method of claim 1, wherein the particles of the plastic have a size distribution between 0.1 to 6 mm.

13. The method of claim 1, wherein the at least one cementitious binder is selected from the group consisting of GGBS, cement, fly ash, Portland cement, and a mixture thereof.

14. The method according to claim 1, wherein the plastic is a synthetic or semi-synthetic plastic, or a rubber, preferably synthetic or semi-synthetic plastic, more preferably a synthetic plastic, optionally wherein the plastic is derived from waste plastic, such as waste plastic-based foam.

15. The method according to claim 1, wherein the plastic-based foam comprises polyurethane (PUR) or polyisocyanurate (PIR), preferably PUR.

16. (canceled)

17. A method of carbonating a plastic aggregate pellet comprising:
i. providing a plastic aggregate pellet comprising a) a plastic particle, b) at least one cementitious binder comprising at least one metal oxide or at least one metal silicate, and c) water,
ii. carbonating the at least one metal oxide or at least one metal silicate by means of an active carbonation process to obtain the carbonated plastic aggregate.

18. The method according to claim 17, wherein the particles of the plastic have a size distribution between 0.2 to 5 mm.

19. The method according to claim 17, wherein the at least one cementitious binder is selected from the group consisting of GGBS, cement, fly ash, Portland cement and a mixture thereof.

20. The method according to claim 17, wherein the plastic aggregate pellet comprises at least one inorganic base, preferably alkali hydroxide, alkali oxide or alkali carbonate or a mixture thereof, preferably sodium hydroxide, sodium carbonate or a mixture thereof.

21. The method according to claim 17, wherein the plastic is a synthetic or semi-synthetic plastic, or a rubber, preferably synthetic or semi-synthetic plastic, more preferably a synthetic plastic, optionally wherein the plastic is derived from waste plastic, such as waste plastic-based foam.

22. The method according to claim 17, wherein the plastic is plastic-based foam, preferably the plastic-based foam comprises polyurethane (PUR) or polyisocyanurate (PIR), preferably PUR.

23-25. (canceled)
